(19) United States
(12) Patent Application Publication
(10) Pub. No.: US 2023/0063921 A1
(43) Pub. Date: Mar. 2, 2023

(54) RECOATABLE COATING COMPOSITION AND METHOD OF COATING SUBSTRATES WITH SUCH COMPOSITIONS

(71) Applicant: BASF Coatings GmbH, Münster (DE)

(72) Inventors: Gina Staniford, Münster (DE); Andreas Dopp, Münster (DE); Lea Fedeler, Münster (DE); Markus Saedler, Münster (DE); Elke Westhoff, Münster (DE)

(21) Appl. No.: 17/760,004

(22) PCT Filed: Jan. 20, 2021
(86) PCT No.: PCT/EP2021/051147

§ 371 Date: Aug. 3, 2022

(30) Foreign Application Priority Data
Feb. 3, 2020 (EP) 20155073.8

(51) Int. Cl. C09D 175/06; C08G 18/72; C08G 18/76; C08G 18/24; C08G 18/28; C08G 18/48; C08G 18/62; C08G 18/40; C08G 18/42; C08G 18/79; B05D 7/00

(52) U.S. Cl. CPC C09D 175/06; B05D 7/542; B05D 7/584; C08G 18/246; C08G 18/281; C08G 18/283; C08G 18/725; C08G 18/792; C08G 18/4063; C08G 18/4244; C08G 18/4825; C08G 18/6225; C08G 18/7671

(57) ABSTRACT

Disclosed herein are a recoatable coating composition suitable for use in in-mold coating processes, methods of coating substrates with such compositions, and coated substrates obtained by said method.

The present invention relates to a recoatable coating composition suitable for use in in-mold coating processes, to methods of coating substrates with such compositions and coated substrates obtained by said method.

### STATE OF THE ART

There is a continuing need for materials which permit weight reduction of vehicle bodies and their parts, particularly for the purpose of reducing fuel requirements and hence carbon dioxide emissions. In addition, the materials must be easy to shape and thus allow a maximum freedom of design. Suitable substrates of the prior art, which already allow a certain weight reduction are, for example, aluminum and high-performance steels. In the last few years, materials such as fiber-reinforced composite materials or fiber-reinforced plastics are increasingly coming into the focus of the designers. Such materials play a role, in particular in the area of the motor vehicle roof, the bonnet, the motor vehicle doors and the rear parts.

However, reinforced composite materials can usually not be coated using conventional painting lines and it is difficult to achieve an excellent surface quality after coating (also called class A surface hereinafter). The problems associated with the surface quality of the coating result from the irregular surface structure of the reinforced composite material propagating to the uppermost paint layer of coating. This propagation is due to the presence of different thermal expansion coefficients of the fibers in the fiber reinforced material and the surrounding plastic matrix. This is especially problematic with respect to visible components in the field of vehicle bodies.

In order to obtain an excellent surface quality after coating, a multilayer coating process comprising the application of several filler, basecoat and clearcoat layers with intermediate sanding steps and a final polishing step is used in the state of the art. Since this process is time consuming, it is desirable to replace the plurality of coating layers and intermediate sanding steps by a single coating layer which can be applied in a thickness sufficient to prevent propagation of substrate irregularities to the surface of this coating layer, which has an excellent adhesion to the substrate and which can be re-coated with further coating compositions without the use of cleaning and/or sanding steps.

Possible methods with which variable and also high layer thicknesses can be produced are the overmolding process (injection-in-mold coating process) or the conventional in-mold coating process. In the conventional in-mold coating process the surface of the mold cavity is coated with the coating composition before the substrate is pressed onto the not or not yet fully cured coating composition or before a component forming composition, for example a polymeric foam material, is applied onto the not or not yet fully cured coating composition. In the overmolding process, the coating composition is injected into a gap between the substrate and the mold surface. Since it is not possible to flash off or dry the coating composition in such overmolding processes, it is only possible to use coating compositions which are free or almost free of volatile components in the overmolding process. Such solvent-free coating compositions usually have a solid content of 100%. In practice, however, such compositions may also contain very small amounts of volatile organic solvents, which are usually introduced into the composition via additives which are dissolved in such solvents. Therefore, coating compositions containing solid contents of slightly less than 100%, for example of at least 96%, are used in practice. Since to the gap width between the substrate and the mold surface can be controlled precisely, the layer thickness obtained in the overmolding process can be exactly defined.

In all processes in which the coating composition is in contact with a mold surface, a damage-free removal of the coated substrate from the mold surface is required. Such damage-free removal can be facilitated by using external release agents applied on the mold surface before the substrate or component forming composition is inserted or applied into the mold cavity. However, such external release agents adhere to the substrate or molded component and have to be removed prior to the application of further coating layers or the adhesive bonding to other components; such removal entails costly and inconvenient cleaning and/or sanding processes. Additionally, the molds used must also be subjected to ongoing cleaning. Further disadvantages associated with the use of external mold release agents include a frequent lack of compatibility between release agent and the substrate and/or component forming composition and/or mold surface, leading to adhesion problems. When external release agents are used, moreover, there is an increase in the cost and complexity of the process and hence in the operating times.

It is therefore desirable to coat the substrate directly during the molding process with a single coating layer suitable to hide the surface irregularities such that a class A surface is resulting after recoating of the already coated substrate or component. Furthermore, the obtained coating film should be recoatable with further coating layers without prior cleaning and/or sanding steps and should provide an excellent adhesion to the substrate as well as an excellent interlayer adhesion to the further coating layer applied on the obtained coating film.

### OBJECT

Accordingly, the object of the present invention is to provide a coating composition suitable for coating a wide variety of substrates, for example plastic, fiber reinforced composite materials, polymeric foam materials etc., which — without the use of an external release agent — permits damage-free demolding from the usually metallic mold cavity, while at the same time resulting in outstanding adhesion on the molded component. Furthermore, the produced coating films ought to be able to be recoated with further coating films, for example a primer and/or basecoat and/or clearcoat film, without prior cleaning and/or sanding steps to obtain a class A surface. Additionally, the obtained coating films should possess a high interlayer adhesion to further coating films applied on top of obtained coating films. Finally, the coating composition ought to have a high storage stability and ought to be rapidly curable under conditions usually used in overmolding and in-mold coating processes.

### Technical Solution

The objects described above are achieved by the subject matter claimed in the claims and also by the preferred embodiments of that subject matter that are described in the description hereinafter.

A first subject of the present invention is therefore a coating composition comprising —based on the total weight of the coating composition —
a) at least one solvent S in a total amount of at least 4% by weight;
b) at least one compound of the general formula (I)

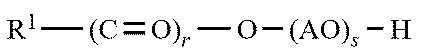

in which
   R¹ is a saturated or unsaturated, aliphatic hydrocarbon radical having 6 to 30 carbon atoms,
   AO stands for one or more alkylene oxide radicals selected from the group consisting of ethylene oxide, propylene oxide and butylene oxide,
   r is 0 or 1, and
   s is 0 to 30;
c) at least one binder B;
d) at least one crosslinker CL;
e) at least one crosslinking catalyst CCAT selected from tin carboxylates, zirconium chelates, aluminum chelates, zinc complexes, zinc carboxylates and mixtures thereof;
f) optionally at least one polyether-modified alkylpolysiloxane; and
g) optionally at least one reactive diluent,
wherein the coating composition comprises 0 % by weight of alkylpolysiloxanes comprising at least one structural unit of general formula (II)

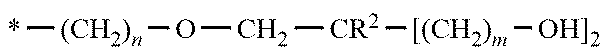

in which
R² is a saturated or unsaturated aliphatic hydrocarbon radical having 1 to 10 carbon atoms,
n is from 1 to 6, and
m is from 1 to 4.

The above-specified coating composition is hereinafter also referred to as coating composition of the invention and accordingly is a subject of the present invention. Preferred embodiments of the coating composition of the invention are apparent from the description hereinafter and also from the dependent claims.

In light of the prior art it was surprising and unforeseeable for the skilled worker that the object on which the invention is based could be achieved by using at least one compound of general formula (I) in combination with at least one binder B and at least one crosslinker CL. The use of said combination results in excellent adhesion and flexibility of the formed coating layer on the substrate while at the same time leading to excellent demolding of the coated substrate from the mold cavity. Surprisingly, the excellent demolding is achieved irrespective of the binder/crosslinker system and without the use of alkylpolysiloxanes of general formula (II) known to increase the demolding of in-mold coatings. Thus, the inventive coating composition is highly versatile and allows to adapt the binder/crosslinker system to the substrate as well as the desirable properties of the cured coating layer without negatively influencing the excellent demolding of the coated substrate from the mold cavity. Since the inventive coating composition is preferably a liquid coating composition, it can be applied easily and uniformly on the surfaces of the mold cavity, thus resulting in a uniform coating layer. The coating layers obtained from the inventive coating composition can be re-coated with conventional solvent-based or aqueous pigmented and unpigmented coating compositions without prior sanding and/or cleaning steps. After the re-coating process, a class A surface on the substrate comprising the multilayer coating is achieved without time-consuming intermediate sanding steps and/or final polishing steps. The inventive coating composition can be flashed off and cured rapidly, thus allowing short process cycles during the manufacture of the coated substrates. Moreover, the inventive coating compositions have a high storage stability.

A further subject of the present invention is a method for producing a coated component, comprising
(1) applying at least one inventive coating composition to at least one surface of a mold cavity of a mold tool;
(2) forming a coating film from the coating composition applied in step (1);
(3) applying at least one composition forming the component into the mold cavity coated with the coating film, wherein the mold tool is closed prior or after application of the composition forming the component or inserting at least one preform into the mold cavity coated with the coating film and closing the mold tool;
(4) jointly curing the coating film obtained after step (2) and the composition applied in step (3) or the preform inserted in step (3);
(5) removing the coated component from the mold cavity; and
(6) optionally applying at least one further pigmented or unpigmented coating composition being different from the coating composition applied in step (1) to the cured coating film obtained after step (4), forming a film from said at least one further coating composition and curing said at least one further coating composition.

Yet another subject of the present invention is a method for producing a coated component, comprising
(1) applying at least one inventive coating composition to at least one surface of a mold cavity of a mold tool;
(2) forming a coating film from the coating composition applied in step (1);
(3) Inserting a substrate to be coated into the mold cavity of the mold tool and partially closing the mold tool;
(4) applying at least one composition into the at least partially opened mold cavity of the mold tool;
(5) jointly curing the coating film obtained after step (2) and the composition injected in step (4);
(6) removing the coated component from the mold cavity; and
(7) optionally applying at least one further pigmented or unpigmented coating composition being different from the coating composition applied in step (4) to the cured coating film obtained after step (5), forming a film from said at least one further coating composition and curing said at least one further coating composition.

A final subject of the present invention is a coating obtained by the inventive method.

### DETAILED DESCRIPTION

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

All temperatures elucidated in the context of the present invention should be understood as the temperature of the room in which the substrate or the coated substrate is located. It does not mean, therefore, that the substrate itself is required to have the temperature in question.

### Inventive Coating Composition

### Solvent S (a)

The inventive coating composition is a preferably a liquid coating composition at 23° C. and therefore comprises as first mandatory ingredient at least one solvent S in an amount of at least 4% by weight. The at least one solvent S is preferably selected from organic solvents, water or mixtures thereof, preferably organic solvents.

Particularly preferred inventive coating compositions are therefore solvent-based coating compositions, i.e. they comprise water and/or protic solvents in a total amount of less than 5% by weight, more preferably less than 3% by weight, very preferably less than 1% by weight, based on the total weight of the coating composition.

Suitable organic solvents are all solvents commonly used in solvent-based coating compositions, for example aliphatic and/or aromatic hydrocarbons, such as toluene, xylene, solvent naphtha, Solvesso 100 or Hydrosol® (from APAL), ketones, such as acetone, methyl ethyl ketone or methyl amyl ketone, esters, such as ethyl acetate, butyl acetate, pentyl acetate or ethyl ethoxypropionate, amides, methylal, butylal, 1,3-dioxolane, glycerol formal, hydrocarbons and mixtures thereof. Preferred organic solvents are esters, very preferably n-butyl acetate and/or 1-methoxypropyl acetate and/or 2-butoxyethylacetat.

The organic solvents or solvent mixtures preferably have a water content of not more than 1% by weight, more preferably not more than 0.5% by weight, based on the solvent. However, some additives or catalysts used herein are sold in protic organic solvents, therefore, in some cases, it cannot be avoided to introduce some unwanted protic solvents, unless a solvent exchange is carried out before their use. If the amount of such protic solvents is kept in the above limits, such amounts can typically be neglected. If undesired premature crosslinking occurs due to the presence of protic solvents, e.g. introduced by additives, such additives are preferably introduced into the coating composition just prior to the application of the coating composition. Another possibility is to perform a solvent-exchange.

The at least one solvent S, preferably esters, very preferably n-butyl acetate and/or 1-methoxypropyl acetate and/or 2-butoxyethylacetat, are preferably present in a total amount of 4 to 50% by weight, more preferably 4 to 40% by weight, even more preferably 4 to 30% by weight, very preferably 4 to 20% by weight, based in each case on the total weight of the coating composition.

### Compound of General Formula (I) (b)

The composition of the invention comprises, as a second essential constituent, at least one compound of the formula (I):

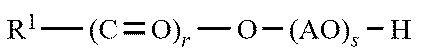

in which
R¹ is a saturated or unsaturated, aliphatic hydrocarbon radical having 6 to 30 carbon atoms,
AO stands for one or more alkylene oxide radicals selected from the group consisting of ethylene oxide, propylene oxide and butylene oxide,
r is 0 or 1, and
s is 0 to 30.

The residue R¹ is preferably an acyclic residue and is more preferably a saturated or unsaturated aliphatic hydrocarbon radical having 8 to 15 carbon atoms, even more preferably 10 to 24 carbon atoms.

If more than one radical AO is present, said radicals may be identical or different and may have a random, block wise or gradient like arrangement. Preferred radicals AO are alkylene oxide radicals selected from the group consisting of ethylene oxide and propylene oxide.

Where at least two different kinds of AO radicals are present, it is preferred if the fraction of ethylene oxide is more than 50 mol%, more preferably at least 70 mol%, and very preferably 70 to 99 mol%, based on the total molar amount of all radicals AO present in general formula (I). In the aforementioned cases, the radicals different from ethylene oxide are preferably propylene oxide radicals.

Where r = 0 and s > 0, the compounds of general formula (I) are alkoxylated fatty alcohols, preferably ethoxylated fatty alcohols. Where r = 1 and s > 0, the compounds of general formula (I) are alkoxylated fatty acids, preferably ethoxylated fatty acids.

With particular preference, for some or all the compounds of general formula (I), s is 2 to 28, preferably 4 to 25, very preferably 6 to 20. With particular preference residue R¹ is in this case a saturated or unsaturated, aliphatic hydrocarbon radical having 10 to 24 carbon atoms.

It is also possible to use mixtures of compounds of general formula (I) in which s is 0 for at least one compound while for at least one further compound s is > 0, preferably 1 to 25 or 2 to 24, more preferably 4 to 22 or 6 to 20, and very preferably 8 to 18.

In particularly preferred compounds of general formula (I), residue R¹ is a saturated or unsaturated aliphatic hydrocarbon radical having 10 to 24 carbon atoms, AO stands for one or more alkylene oxide radicals selected from the group consisting of ethylene oxide and propylene oxide, r is 0 or 1, and s is 0 or 1 to 25.

In further particularly preferred compounds of general formula (I), residue R¹ is a saturated or unsaturated aliphatic hydrocarbon radical having 10 to 24 carbon atoms, AO stands for one or more alkylene oxide radicals selected from the group consisting of ethylene oxide and propylene oxide and the ethylene oxide fraction in the total molar amount of the radicals AO is at least 70 mol%, r = 0 or 1, and s = 0 or s = 6 to 20.

Especially preferred are mixtures which comprise the aforesaid alkoxylated fatty alcohols with s > 0 and at least one further species selected from fatty acids with r = 1 and s = 0.

The total weight of the compound of the general formula (I) is preferably 0.1 to 10% by weight, more preferably 0.4 to 7% by weight, even more preferably 0.6 to 6% by weight, very preferably 0.8 to 4% by weight, based in each case on the total weight of the coating composition. Where more than one compound of the formula (I) is used, the amounts indicated above are based on the total amount of all compounds which fall under general formula (I). If the compound of the formula (I) is limited to a particular compound (I-1), then the amounts indicated above are based not merely on the particular compound (I-1) but instead on the total amount of compounds which fall under general formula (I). If, for example, the particular compound (I-1) is used in an amount of 5% by weight, then there may be at most 5% by weight of further compounds falling under general formula (I) present in the composition of the invention.

### Binder (c)

The inventive coating composition is a film forming composition and thus comprises at least one binder B as third mandatory ingredient. The term “binder” in the sense of the present invention and in agreement with DIN EN ISO 4618 (German version, date: March 2007) refers preferably to those nonvolatile fractions of the composition of the invention that are responsible for film formation, with the exception of any pigments and fillers included therein; more particularly, to the polymeric resins which are responsible for film formation. The nonvolatile fraction may be determined by the method described in the Examples section.

Surprisingly, an excellent demolding as well as an excellent quality of the cured coating layer, especially an excellent adhesion, recoatability and adhesive bonding, is achieved with cured inventive coating compositions irrespective of the nature of the binder B. The composition of the invention can therefore contain any crosslinkable binder B, without adversely affecting the demoldability of the produced coated component or the outstanding properties of the coating layer produced with the inventive coating composition.

Suitable binders B are selected from the group consisting of (i) poly(meth)acrylates, more particularly hydroxy-functional and/or carboxylate-functional and/or amine-functional poly(meth)acrylates, (ii) polyurethanes, more particularly hydroxy-functional and/or carboxylate-functional and/or amine-functional polyurethanes, (iii) polyesters, more particularly polyester polyols and polycarbonate polyols, (iv) polyethers, more particularly polyether polyols, (v) copolymers in the stated polymers, and (vi) mixtures thereof, preferably (i) hydroxy-functional poly(meth)acrylates and/or (ii) hydroxy-functional polyurethanes and/or (iii) polyesters, more particularly polyester polyols and polycarbonate polyols and/or (iv) polyethers, more particularly polyether polyols. The term “poly(meth)acrylate” refers both to polyacrylates and to polymethacrylates. Poly(meth)acrylates may therefore be composed of acrylates and/or methacrylates and may comprise further ethylenically unsaturated monomers, such as alkyl (meth)acrylates, styrene or (meth)acrylic acid, for example.

Particularly suitable binders B are selected from
branched polyester polyols and/or hydroxy-functional poly(meth)acrylates or
hydroxy-functional poly(meth)acrylates and linear aliphatic polycarbonate polyols.

The term “aliphatic polycarbonate polyol” refers herein to a polycarbonate polyol exclusively containing acyclic or cyclic, saturated or unsaturated residues, i.e. said polyol does not containing any aromatic residues. Aliphatic polycarbonate polyols may accordingly, however, contain heteroatoms, such as oxygen or nitrogen, for example.

The branched polyester polyol preferably has a hydroxy content of 5 to 25%, more preferably 10 to 20%, very preferably 12 to 18%, as determined according to DIN 53240-2:2007-11. The branched polyester polyol preferably only contains a rather small amount of acid-functional groups. Thus, the acid number of the branched polyester polyol is preferably 0 to 6 mg KOH/g solids, more preferably 1 to 3 mg KOH/g solids, as determined according to DIN EN ISO 2114:2002-06. The branched polyester polyol preferably has a viscosity at 23° C. of 1,000 to 4,000 mPa*s, more preferably 1,300 to 3,000 mPa*s, very preferably 1,600 to 2,200 mPa*s, as determined according to DIN EN ISO 3219:1994-10, procedure A.3. Suitable branched polyester polyols are commercially available, for example under the tradename Desmophen® VP LS 2249/1 sold by Covestro Deutschland AG.

If the inventive coating composition contains a branched polyester polyol as binder B, said branched polyester polyol is preferably present in a total amount (solids content) of 1 to 65% by weight, more preferably 2 to 55% by weight, very preferably 3 to 5% by weight or 35 to 45% by weight, based in each case on the total amount of the coating composition.

Suitable hydroxy-functional poly(meth)acrylates have a hydroxyl number of 50 to 200 mg KOH/g, preferably of 90 to 160 mg KOH/g, more particularly of 110 to 130 mg KOH/g or of 135 to 145 mg KOH/g, as determined according to DIN 53240-2:2007-11, procedure A. Since the inventive coating composition is preferably an organic-based coating composition, the acid number of the hydroxy-functional poly(meth)acrylates is favorably rather low. Thus, preferred hydroxy-functional poly(meth)acrylates have an acid number of 0 to 15 mg KOH/g solids, more preferably 1 to 10 mg KOH/g solids, very preferably 1 to 4 mg KOH/g solids or 6 to 9 mg KOH/g solids, as determined according to DIN EN ISO 2114:2002-06. Moreover, preferred hydroxy-functional poly(meth)acrylates have a number-average molecular weight Mₙ of 800 to 5,000 g/mol, more preferably 1,000 to 4,000 g/mol, very preferably 1,100 to 2,400 g/mol or 1,700 to 3,000 g/mol, as determined with gel permeation chromatography using polystyrene as internal standard. Suitable hydroxy-functional poly(meth)acrylates are commercially available, for example under the tradenames Acrylique TSA Uno and Acrylique 3,5 sechage rapid sold by BASF SE.

If the inventive coating composition contains a hydroxy-functional poly(meth)acrylate as binder B, said hydroxy-functional poly(meth)acrylate is preferably present in a total amount (solids content) of 1 to 75% by weight, preferably 55 to 65% by weight, based in each case on the total amount of the coating composition.

The linear aliphatic polycarbonate polyol preferably has a hydroxy content of 0.1 to 10%, more preferably 0.5 to 5%, very preferably 1 to 3%, as determined according to DIN 53240-2:2007-11. Moreover, the linear aliphatic polycarbonate polyol preferably has an acid number of 0 to 6 mg KOH/g solids, more preferably of 0.05 to 0.5 mg KOH/g solids, as determined according to DIN EN ISO 2114:2002-06. The viscosity of the linear aliphatic polycarbonate polyol at 23° C. is preferably 5,000 to 40,000 mPa*s, more preferably 10,000 to 30,000 mPa*s, very preferably 13,00 to 20,000 mPa*s, as determined according to DIN EN ISO 3219:1994-10, procedure A.3.

If the inventive coating composition contains a linear aliphatic polycarbonate polyol as binder B, said linear aliphatic polycarbonate polyol is preferably present in a total amount (solids content) of 10 to 40% by weight, more preferably 12 to 30% by weight, very preferably 18 to 25% by weight, based in each case on the total amount of the coating composition.

The at least one binder B is present preferably in a total amount of 40 to 95 wt.% solids, preferably 45 to 90 wt.% solids, more preferably 50 to 85 wt.% solids, very preferably 60 to 80 wt.% solids, based in each case on the total weight of the composition. If the binder is present in a dispersion or solution, the above-recited total amounts are calculated using the solids content of the dispersion or solution in each case. The use of the at least one binder B in the above-recited amounts ensures the formation of a coating layer having an excellent quality, especially adhesion, recoatability and adhesive bonding, without negatively influencing the high demoldability.

### Crosslinker CL (d)

As fourth mandatory component, the inventive coating composition comprises at least one crosslinker CL. Said crosslinker CL comprises at least one reactive functional group which is able to undergo crosslinking reactions with complementary reactive functional groups present in the at least one binder B. Since the at least one binder B preferably contains reactive functional groups in the form of hydroxyl groups, preferred reactive functional groups which are able to undergo crosslinking reactions with such hydroxyl groups are isocyanate groups, amino groups or carbodiimide groups.

The at least one crosslinker CL is preferably selected from amino resins, unblocked polyisocyanates, blocked polyisocyanates, polycarbodiimides and mixtures thereof, preferably polyisocyanates.

Particular preference is given to using unblocked polyisocyanates, i.e. compounds containing at least two free isocyanate groups.

In this context, it is particularly preferred if the polyisocyanate has an NCO content of 10 to 50% by weight, preferably 15 to 40% by weight, very preferably 20 to 25% by weight or 28 to 35% by weight, as determined according to DIN EN ISO 11909:2007-05 or ASTM D 5155-2014.

The polyisocyanate preferably comprises oligomers, preferably trimers or tetramers, of diisocyanates. With particular preference it comprises iminooxadiazinediones, isocyanurates, allophanates and/or biurets of diisocyanates. With particular preference the polyisocyanate comprises aliphatic and/or cycloaliphatic, very preferably aliphatic, polyisocyanates. Serving as a diisocyanate basis for the aforementioned oligomers, more particularly the aforementioned trimers or tetramers, is very preferably hexamethylene diisocyanate and/or isophorone diisocyanate and/or methylene diphenyl diisocyanate, and especially preferably hexamethylene diisocyanate and/or methylene diphenyl diisocyanate.

Employed with particular preference in the context of the present invention are polyisocyanates which comprise at least one isocyanurate ring or at least one iminooxadiazinedione ring.

The hardness, flexibility, and elasticity of the resulting cured coating layer can be influenced by selecting an appropriate crosslinker CL. Use of polyisocyanates containing iminooxadiazinedione structures, in particular, leads to coating layers having a high hardness, thereby preventing substrate structures propagating through to the cured coating surface and causing unwanted waviness. Such polyisocyanates are available for example from Covestro under the name Desmodur N3900. Similar results may be achieved with polyisocyanates containing isocyanurate structures, as available for example under the name Desmodur N3800 from Covestro, in which case the coating layers are more flexible than coating layers obtained when using polyisocyanates containing iminooxadiazinedione structures.

According to an alternative embodiment, two polyisocyanates P1 and P2 being different from each another may be present as crosslinker CL, with the first polyisocyanate P1 comprising at least one isocyanurate ring and the second polyisocyanate P2 being a polymeric methylene diphenyl diisocyanate.

The composition preferably comprises the at least one crosslinker CL, preferably polyisocyanates, in a total amount of 5 wt.% to 70 wt.%, more preferably of 10 to 65 wt.%, more particularly of 15 to 60 wt.%, based in each case on the total weight of the composition. In case a mixture of different crosslinkers CL is used, the afore-stated amounts refer to the sum of all crosslinkers CL present in the inventive coating composition.

It is preferred, furthermore, if the inventive coating composition comprises a particular molar ratio of the functional groups of the crosslinker CL to the sum of the complementary reactive functional groups present groups in the at least one binder B. This ensures a sufficient crosslinking of the composition of the invention under curing conditions. It is therefore advantageous if the molar ratio of the functional groups of the crosslinker CL, more particularly of the NCO groups of the polyisocyanates, to the sum of the complementary reactive functional groups present groups in the at least one binder B, more particularly hydroxyl groups, is 1.5:1 to 1:1.5, preferably 1.2:1 to 1:1.2, more particularly 1:1.

### Alkylpolysiloxanes

The inventive coating composition does not contain any alkylpolysiloxanes comprising at least one structural unit of general formula (II) as previously described.

With particular preference, the inventive coating composition does not comprise any alkylpolysiloxanes containing at least one structural unit of general formula (II), wherein residue R² in said general formula (II) is a linear saturated aliphatic hydrocarbon radial having 2 carbon atoms, n is 3 and m is 1. Such alkylpolysiloxanes are, for example, commercially available under the tradename Silmer® OHT Di-10, Silmer® OHT Di-50 or Silmer® OHT Di-100 from Siltech Corporation and are silicone polymers in which each end is functionalized with a branched alkyl group bearing two primary hydroxyl groups.

Surprisingly, an excellent demoldability can be achieved with the inventive coating composition even in the absence of said alkylpolysiloxanes known to improve the demolding of the coated object from the mold tool.

### Crosslinking Catalyst CCAT

Furthermore, the composition comprises at least one crosslinking catalyst CCAT. Said crosslinking catalyst CCAT serves primarily to catalyze the reaction between the functional groups of the crosslinker CL and the complementary reactive functional groups of the at least one binder B and optionally the at least one reactive diluent.

The at least one crosslinking catalyst CCAT is selected from tin carboxylates, tin mercaptides, zirconium chelates, aluminum chelates, zinc complexes, zinc carboxylates and mixtures thereof, more preferably from tin carboxylates, very preferably from dioctyltin dilaurate.

With particular preference, the tin carboxylate, preferably the dioctyltin dilaurate, has a tin content of 10 to 25%, more preferably 12 to 20%, based on the total weight of the tin carboxylate.

The metal carboxylates, more preferably the tin carboxylates, are preferably used in stabilized form in combination with the parent carboxylic acid of the carboxylate, i.e. HOOC(CₙH₂ₙ₊₁), in which n possesses the definition indicated above.

Suitable tin mercaptides are dialkyltin dimercaptides, preferably dialkyltin dimercaptides of general formula (IV)

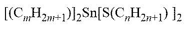

with m = 1 to 10, preferably m = 4 to 8, and n = 6 to 16, preferably n = 8 to 14, very preferably n = 10 to 12. Particularly preferred dialkyltin dimercaptides are dimethyltin dilaurylmercaptide.

The coating composition of the invention may comprise the at least one crosslinking catalyst CCAT in a total amount of 0.1 to 5% by weight, preferably 0.2 to 3% by weight, very preferably 0.2 to 0.8% by weight, based on the total weight of the coating composition.

### Further Ingredients of the Inventive Coating Composition

The inventive coating composition can comprise — apart from the afore-stated mandatory components — further components as described below.

### Polyether-Modified Alkylpolysiloxane

The composition of the invention may further comprise at least one polyether-modified alkylpolysiloxane. The term “polyether-modified alkylpolysiloxane” in accordance with the invention represents an alkylpolysiloxane which is modified with polyether groups at the terminal ends and/or in the main chain. These polyether groups may be bonded directly and/or via an alkyl group to the silicon atom of the alkylpolysiloxane. The polyether groups are preferably bonded directly to the silicon atom of the alkylpolysiloxane. Preferred polyether groups present are ethylene oxide, propylene oxide and butylene oxide groups.

The use of such polyether-modified alkylpolysiloxane leads to reduced staining of the cured coating layer by environmental influences, like dirt.

Preferably the polyether-modified alkylpolysiloxane comprises at least one structural unit (R⁴)₂(OR³)SiO_{½} and at least one structural unit (R⁴)₂SiO_{2/2}, where R³ is an ethylene oxide, propylene oxide, and butylene oxide group, more particularly a mixture of ethylene oxide and propylene oxide and butylene oxide groups, and R⁴ is a C₁-C₁₀ alkyl group, more particularly a methyl group.

It is preferred in this context if the polyether-modified alkylpolysiloxane has a molar ratio of siloxane to ethylene oxide groups to propylene oxide groups to butylene oxide groups of 6:21:15:1 to 67:22:16:1.

It is preferred in this context, furthermore, if the polyether-modified alkylpolysiloxane has a molar ratio of the structural unit (R⁴)₂(OR³)SiO_{½} to the structural unit (R⁴)₂SiO_{2/2} of 1:10 to 1:15, more particularly of 1:10 to 1:13. R³ and R⁴ here have the definitions recited above.

The at least one polyether-modified alkylpolysiloxane preferably has a refractive index of 1.4 to 16, more preferably 1.42 to 1.46, as determined according to DIN 51423-2:2010-02 at 23° C. Due to the high refractive index, said polyether-modified alkylpolysiloxane is transparent and can therefore be used in inventive coating composition which should result in transparent cured coating layers.

The at least one polyether-modified alkylpolysiloxane preferably has a viscosity of 300 to 1,500 mPa*s, more preferably 400 to 1,000 mPa*s, very preferably 500 to 900 mPa*s, as determined according to DIN 53015:2001-02 at 23° C.

The composition may comprise 0 to 15% by weight, preferably 1 to 12% by weight, very preferably 1.5 to 10% by weight, based in each case on the total weight of the coating composition, of polyether-modified alkylpolysiloxanes, more particularly of the specific polyether-modified alkylpolysiloxanes recited above. The absence of such compounds can reduce the tackiness of the inventive coating composition and might therefore improve the demolding properties.

### Reactive Diluent

The term reactive diluent refers to low weight monomers which are able to participate in the polymerization reaction of the at least one binder B and the at least one crosslinker CL during formation of a polymeric material. The weight average molecular weight M_{w} of such monomer compounds is preferably less than 1,500 g/mol and more preferably less than 900 g/mol, as determined by GPC using polystyrene as internal standard.

Preferably, the at least one reactive diluent is selected from hydroxy-group containing compounds, more preferably polyethylene oxide and/or polypropylene oxide, very preferably polypropylene oxide.

The at least one reactive diluent preferably has a weight-average molecular weight M_{w} of 500 to 1,500 g/mol, more preferably 600 to 1,200 g/mol, very preferably 800 to 1,000 g/mol , as determined by gel permeation chromatography using polystyrene as internal standard.

Moreover, the at least one reactive diluent preferably has a kinematic viscosity at 20° C. of 100 to 400 mm²/s (cst), more preferably of 140 to 200 mm²/s (cst), very preferably of 170 to 200 mm²/s (cst), as determined according to DIN 51562:1999-01.

The inventive coating composition may comprise the at least one reactive diluent in a total amount of 0 to 5% by weight, preferably 0.1 to 3% by weight, very preferably 0.3 to 1% by weight, based in each case on the total amount of the coating composition.

### Pigments/Fillers

The composition may further comprises at least one pigment and/or at least one filler. Suitable pigments are, for example, all organic and inorganic coloring pigments, effect pigments and mixtures thereof commonly used in aqueous and solvent-based coating composition. Such color pigments and effect pigments are known to those skilled in the art and are described, for example, in Römpp-Lexikon Lacke und Druckfarben, Georg Thieme Verlag, Stuttgart, New York, 1998, pages 176 and 451. The terms “coloring pigment” and “color pigment” are interchangeable, just like the terms “visual effect pigment” and “effect pigment”.

The use of pigments and/or fillers is advantageous if colored coating layers should be obtained. Surprisingly, the use of pigments and/or fillers in the compositions of the invention does not negatively influence the demoldability, the adhesion and the recoatability of the cured coating layers. Accordingly, it is possible to obtain a coating layer which already has the desired color directly after production, so that there is no need for the application of further coating layers to obtain the desired color.

Examples of inorganic coloring pigments include (i) white pigments, such as titanium dioxide, zinc white, colored zinc oxide, zinc sulfide, lithopone; (ii) black pigments, such as iron oxide black, iron manganese black, spinel black, carbon black; (iii) color pigments, such as ultramarine green, ultramarine blue, manganese blue, ultramarine violet, manganese violet, iron oxide red, molybdate red, ultramarine red, iron oxide brown, mixed brown, spinel and corundum phases, iron oxide yellow, bismuth vanadate; (iv) filer pigments, such as silicon dioxide, quartz flour, aluminum oxide, aluminum hydroxide, natural mica, natural and precipitated chalk, barium sulphate and (vi) mixtures thereof.

Suitable organic coloring pigments are selected from (i) monoazo pigments such as C.I. Pigment Brown 25, C.I. Pigment Orange 5, 36 and 67, C.I. Pigment Orange 5, 36 and 67, C.I. Pigment Red 3, 48:2, 48:3, 48:4, 52:2, 63, 112 and 170 and C.I. Pigment Yellow 3, 74, 151 and 183; (ii) diazo pigments such as C.I. Pigment Red 144, 166, 214 and 242, C.I. Pigment Red 144, 166, 214 and 242 and C.I. Pigment Yellow 83; (iii) anthraquinone pigments such as C.I. Pigment Yellow 147 and 177 and C.I. Pigment Violet 31; (iv) benzimidazole pigments such as C.I. Pigment Orange 64; (v) quinacridone pigments such as C.I. Pigment Orange 48 and 49, C.I. Pigment Red 122, 202 and 206 and C.I. Pigment Violet 19; (vi) quinophthalone pigments such as C.I. Pigment Yellow 138; (vii) diketopyrrolopyrrole pigments such as C.I. Pigment Orange 71 and 73 and C.I. Pigment Red, 254, 255, 264 and 270; (viii) dioxazine pigments such as C.I. Pigment Violet 23 and 37; (ix) indanthrone pigments such as C.I. Pigment Blue 60; (x) isoindoline pigments such as C.I. Pigment Yellow 139 and 185; (xi) isoindolinone pigments such as C.I. Pigment Orange 61 and C.I. Pigment Yellow 109 and 110; (xii) metal complex pigments such as C.I. Pigment Yellow 153; (xiii) perinone pigments such as C.I. Pigment Orange 43; (xiv) perylene pigments such as C.I. Pigment Black 32, C.I. Pigment Red 149, 178 and 179 and C.I. Pigment Violet 29; (xv) phthalocyanine pigments such as C.I. Pigment Violet 29, C.I. Pigment Blue 15, 15:1, 15:2, 15:3, 15:4, 15:6 and 16 and C.I. Pigment Green 7 and 36; (xvi) aniline black such as C.I. Pigment Black 1; (xvii) azomethine pigments; and (xviii) mixtures thereof.

Examples of effect pigments include (i) plate-like metallic effect pigments such as plate-like aluminum pigments, gold bronzes, fire-colored bronzes, iron oxide-aluminum pigments; (ii) pearlescent pigments, such as metal oxide mica pigments; (iii) plate-like graphite pigments; (iv) plate-like iron oxide pigments; (v) multi-layer effect pigments from PVD films; (vi) liquid crystal polymer pigments; and (vii) mixtures thereof.

The at least one pigment and/or the at least one filler is preferably present in a total amount of 0.1 wt.% to 10 wt.%, based on the total weight of the composition.

### Additives

The composition of the invention may further comprise at least an additive selected from the group consisting of wetting agents and/or dispersants, rheological assistants, flow control agents, UV absorbers, and mixtures thereof.

The at least one additive is preferably present in a total amount of 0.1 wt% to 10 wt%, based on the total weight of the composition.

Depending on the particular binders B and crosslinkers CL present in the composition of the invention, said composition is configured as a one-component system or is obtainable by mixing at least two (multicomponent system) components. Preferably, the inventive coating composition is configured as a multicomponent system comprising at least two separate components, i.e. the at least one binder B and the at least one crosslinker CL are reactive towards each other and must therefore be stored separately from each other prior to application to avoid an undesired premature reaction. Generally, the binder component and the crosslinker component may only be mixed together shortly before application. The term “shortly before application” is well known to the person skilled in the art. The time period within which the ready-to-use coating composition may be prepared by mixing the components prior to the actual application depends on the pot life of the coating application.

Thus, a preferred multicomponent system (i.e. a kit-of-parts) for the preparation of an inventive coating composition comprises
A) at least one base varnish component comprising the at least one solvent S, the at least one compound of general formula (I), the at least one binder B and the at least one crosslinking catalyst CCAT; and
B) at least one hardener component comprising the at least one crosslinker CL. Since the inventive coating composition does not comprise any alkylpolysiloxanes comprising at least one structural unit of general formula (II), all components of the multicomponent system do likewise not comprise said alkylpolysiloxanes. With respect to the ingredients of base varnish component A) and hardener component B), reference is made to the previously described inventive coating composition.

As previously described, components A) and B) of the kit-of-parts are stored separately and only combined shortly before application.

The at least one base varnish may further comprise at least one polyether-modified alkylpolysiloxane and/or at least one reactive diluent and/or at least one pigment and/or filler and/or at least one additive.

The kit-of-parts can also comprise further components, for example a dilution component C) comprising at least one solvent and optionally at least one rheological assistant to modify the viscosity of the inventive coating composition. The at least one solvent can be identical or different from the solvent S in the base varnish. If a different solvent is used, said solvent is preferably compatible with the solvent S in the base varnish in order to prevent undesired phase separation, agglomeration or precipitation upon mixing. With particular preference, the solvent is identical to the solvent S in the base varnish.

The components A) and B) are preferably mixed in a ratio of 1.5:1 to 1:1.5, more preferably 1.2:1 to 1:1.2, very preferably 1:1. The use of the above-described mixing ratios ensures sufficient crosslinking of the coating composition prepared from the inventive kit-of-parts, resulting in a high adhesion as well as an excellent demoldability.

Mixing may take place manually, with the appropriate amount of a first component A) being introduced into a vessel, admixed with the corresponding quantity of the second component B) and optionally further components. However, mixing of the two or more components can also be performed automatically by means of an automatic mixing system. Such an automatic mixing system can comprise a mixing unit, more particularly a static mixer, and also at least two devices for supplying the binder containing first component A) and the crosslinker containing second component B), more particularly gear pumps and/or pressure valves. The static mixer may be a commercially available helical mixer, which is installed into the material supply line about 50 to 100 cm ahead of the atomizer. Preferably 12 to 18 mixing elements (for each element 1 cm in length, diameter 6 to 8 mm) are used in order to obtain sufficient mixing of the two components. In order to prevent clogging of the material supply line, it is preferred if the mixing unit is programmed so that not only the helical mixer but also the downstream hose line and the atomizer are flushed with the first component every 7 to 17 minutes. Where the composition is applied by means of robots, this flushing operation takes place when the robot head is in a pre-defined position of rest. Depending on the length of the hose line, about 50 to 200 ml are discarded into a catch vessel. A preferred alternative to this procedure is the semi continuous conveying of mixed release agent composition. If composition is forced out regularly (every 7 to 17 minutes, likewise into a catch vessel), it is possible to reduce the quantity of discard material to a minimum (about 10 to 50 ml). Furthermore, provision may be made for the hose line from the mixer to the atomizer, and also the atomizer, to be flushed. This flushing operation is preferred in particular after prolonged downtime of the system or at the end of a shift, in order thus to ensure a long lifetime of the equipment and continuous quality of the composition.

Both in the case of manual mixing and in the case of the supply of the components for automatic mixing, the separate components preferably each possess temperatures of 15 to 70° C., more preferably 15 to 40° C., more particularly 20 to 30° C.

### Inventive Methods

### In-Mold Coating Method

The present invention is further directed to a method for producing a coated component, comprising
(1) applying at least one inventive coating composition to at least one surface of a mold cavity of a mold tool;
(2) forming a coating film from the coating composition applied in step (1);
(3) applying at least one composition forming the component into the mold cavity coated with the coating film, wherein the mold tool is closed prior or after application of the composition forming the component or inserting at least one preform into the mold cavity coated with the coating film and closing the mold tool;
(4) jointly curing the coating film obtained after step (2) and the composition applied in step (3) or the coating film obtained after step (2) and the preform inserted in step (3);
(5) removing the coated component from the mold cavity; and
(6) optionally applying at least one further pigmented or unpigmented coating composition being different from the coating composition applied in step (1) to the cured coating film obtained after step (4), forming a film from said at least one further coating composition and curing said at least one further coating composition.

A component in accordance with the invention means an individual part which, when joined with other components, forms an assembly. If, for example, the component is part of a bodywork of a motor vehicle, it can be assembled with other bodywork components to form a bodywork. In general, however, independently of the purpose of the material as being able to serve as a component, the invention generally relates to the production of coated components and is therefore not limited to components in the above sense. Consequently, where reference is made below to the coating of components, this also generally embraces the coating of materials without a “component” function; in other words, such materials need not necessarily be used as a component for producing assemblies after their production.

A coated component in accordance with the invention means a component which has at least one coating layer on at least one of its surfaces. The coating layer is obtained on the at least one surface of the component by crosslinking of the composition of the invention during the production of said component. The coating layer, accordingly, refers to the crosslinked composition of the invention.

### Step 1

In step (1) of the inventive in-mold coating method, the inventive coating composition as previously described is applied to at least one surface of the mold cavity of a mold tool. The term “surface of the mold cavity” refers in accordance with the invention to the surface of the mold parts that comes into contact with inventive coating composition and also with the component forming composition or preform used during the production of the coated component.

The inventive coating composition is used as release and coating agent to facilitate demolding of the molded component and to simultaneously realize a coating of the molded component during the production process. The coating of the molded component renders post-coating processes superfluous. Moreover, the incorporation of a release agent into the coating composition allows to avoid the use of external release agents which hamper the adhesion of subsequently applied coating layers to the component and therefore require additional cleaning steps before their application.

In order to facilitate demolding of the molded component without damage and coating of said component on all surfaces, the inventive composition is preferably applied on all surfaces of the mold parts facing the mold cavity. However, it is likewise possible to only coat specific areas of the surface or to only coat one of several surfaces of the mold parts.

The mold tool is preferably a three dimensional mold tool having a three dimensional inner cavity which is formed by at least two mold parts that can be moved relative to each other to open and close the mold. The inner cavity of the mold therefore has three dimensions, i.e. a length, width and depth. The mold can have a single cavity or multiple cavities. In multiple cavity molds, each cavity can be identical and form the same parts or can be unique and form multiple different geometries during a single cycle.

The composition used in step (1) can be applied on the at least a part of at least one surface of the mold cavity either manually by using commonly known application gear for liquid coating compositions, for example spray guns, or by means of an application robot. In terms of economy, the use of application robots is preferred. The robots are programmed for the geometry of the mold parts and apply the composition pneumatically and autonomously to the inner surface of the mold parts.

Where the composition is applied by means of application robots, it is preferred in accordance with the invention if, during the application of the composition with deployment of application robots, nozzles are used that have a diameter of 0.05 to 1.5 mm, preferably of 0.08 to 1 mm, more particularly of 0.1 to 0.8 mm. The use of nozzles having the afore-described diameters ensures that the surface(s) of the mold cavity are wetted with the desired amount of the composition.

The mold cavity preferably has a surface temperature in step (1) of 20 to 100° C., preferably 40 to 80° C., very preferably 60 to 70° C. Thus, the mold tool is preferably pre-heated before the application of the composition in step (1). Heating of the mold cavity can be performed by supplying heat or by irradiation, for example IR radiation. Preferably the mold tool and/or the mold cavity is heated by means of IR radiation. In case the mold cavity is preheated, said mold cavity can be open or closed during the preheating. In case the mold cavity is closed during preheating, the mold cavity has to be opened before the composition can be applied.

### Step 2

In step (2) of the in-mold coating process, a film is formed from the composition applied in step (1). The formation of a coating film is preferably performed by flashing off the applied coating composition. This means the active or passive evaporation of solvents present in the composition, usually at a temperature which is higher than the ambient temperature, for example at 40 to 140° C. The composition is still flowable directly after application and at the start of the flashing off and can therefore form a uniform, smooth coating film during the flash off phase. The layer obtained from the coating composition after flashing, however, is not yet in the ready-to-use state. While it is indeed, for example, no longer fluid, it is still soft or tacky, and may have undergone only partial drying. In particular, the layer obtained from coating composition is not yet crosslinked, as described below.

With particular preference, the coating film is formed in step (2) at a temperature of preferably 40 to 80° C., very preferably 60 to 70° C. for a duration of 1 to 60 seconds, preferably 5 to 30 seconds. If the mold cavity is not already heated prior to application of the composition in step (1), it is heated in step (2) in order to obtain the coating film. Heating of the mold cavity can be performed as previously described in connection with step (1). The short flash-off times of the coating composition applied in step (1) allow the realization of short process times, thus allowing an efficient and economic production process. Moreover, the coating composition can be used in processes where short cycle times are essential, for example in the production of shoe soles using the round-table process.

### Step 3

According to the first alternative of step (3) of the inventive in-mold coating process, a component forming composition is applied into the mold cavity coated with the coating film obtained in step (2).

The component forming composition applied in step (3) is preferably selected from (i) polymer foam materials, more particularly selected from polyurethane foam materials, polystyrene foam materials, polyester foam materials, butadiene styrene blockcopolymer foam materials and aminoplast foam materials, very preferably from polyurethane foam materials; (ii) plastic materials, more particularly selected from epoxides, polyamides, polycarbonates, polyesters, polystyrenes, polyurethanes and acrylonitrile butadiene styrenes, very preferably from epoxides and/or polyurethanes and/or polycarbonates.

Polymer foam materials are, in the context of the present invention, thermosets, thermoplastics, elastomers, or thermoelastics from which polymer foams can be produced by a foaming process. In terms of their chemical basis, possible polymer foam materials include for example, but not exclusively, polystyrenes, polyvinyl chlorides, polyurethanes, polyesters, polyethers, polyetheramides, or polyolefins such as polypropylene, polyethylene, and ethylene-vinyl acetate, and also copolymers of the polymers stated. The polymer foams produced can include, among others, elastomeric foams, more particularly flexible foams, but also thermoset foams, more particularly rigid foams, and also integral foams. The foams may be open-cell, closed-cell or mixed-cell foams.

The production of the polymer foam by the foaming process is achieved by curing (i.e. foaming) the applied foam material as described in connection with process step (4). Foaming processes are known, and will therefore be presented only briefly. A fundamental principle in each case is that blowing agents and/or gases in solution in the plastic or in a corresponding plastics melt, and formed in crosslinking reactions in the production of corresponding polymeric plastics, are released and so bring about the foaming of the hitherto comparatively dense polymeric plastics. For example, where a low-boiling hydrocarbon is employed as a blowing agent, it vaporizes at elevated temperatures and leads to foaming. Gases such as carbon dioxide or nitrogen as well can also be introduced into the polymer melt at high pressure and/or dissolved therein, as blowing agents. As a result of a later drop in pressure, the melts then foam during the escape of the blowing agent gas.

Particularly preferred polymer foam materials are polyurethane foam materials. These are customarily produced from one or more polyols and one or more polyisocyanates. The blowing agent added to the polyol component to form the foam is usually water, which reacts with part of the polyisocyanate to form carbon dioxide, the reaction therefore being accompanied by foaming. Soft to elastic foams, especially flexible foams, are obtained using long-chain polyols. If short-chain polyols are used, highly crosslinked structures are formed, leading generally to the formation of rigid foams. The polyols used in producing the polyurethane foam materials preferably comprise polyester polyols, polyether polyols and/or polyester polyether polyols, and are accordingly selected preferably from the group of the aforesaid polyols.

Fibers may be admixed to the polymer foam material. When such materials are foamed, the products are known as fiber-reinforced foams. Fibers are preferably used when producing rigid foams.

Plastic materials are, in the context of the present invention, thermosets, thermoplastics, elastomers, or thermoelastics from which plastic materials can be produced by a crosslinking reaction between two reactive components.

Application may take place by means of devices known in principle. With particular preference the composition is applied automatically in process step (3). Application may be performed by injecting the composition into the closed mold or by spraying the composition into the open mold cavity and closing of the mold tool. The composition can be applied in one step or in a plurality of steps into the mold. Application of the composition in a plurality of steps is preferably carried out when the mold tool comprises a plurality of mold cavities. In that case the composition in a first stage is injected into the first mold cavity and in a second stage is injected into the second mold cavity.

According to the second alternative of step (3) of the inventive process, a preform is inserted into the open mold cavity and the mold tool is afterwards closed.

Particularly preferred preforms are consisting of one or more layers of fibers, wherein said fibers are optionally at least partially coated with a polymeric material. The fibers are preferably present in the form of fiber composites, in particular in the form of fabrics, scrims, knitted fabrics, ribbons, nonwovens and/or mats. Suitable fibers include all fibers commonly used to prepare reinforced materials, for example carbon fibers, glass fibers, aramid fibers, basalt fibers and mixtures thereof.

Suitable polymeric materials include polyesters, polyurethanes, epoxy resins, polyamide resins, vinyl ester resins and formaldehyde phenol resins.

With particular preference, the at least one preform used in step (3) of the inventive process preferably consists of glass fibers, said fibers being optionally at least partially coated with a polymeric material selected from polyesters or polyurethanes. In case the fibers of the preforms are at least partially coated with a polymeric material, said preforms are preferably dried before they are inserted into the mold cavity in step (3) in order to facilitate handling of these preforms. However, the polymeric material is not fully cured in order to obtain a sufficient adhesion of the cured inventive coating material on the surface of said preform and to allow a shaping of the preform during the curing process described later on.

### Step 4

In step (4) of the inventive in-mold coating method, the compositions applied in step (1) and (3) or the composition applied in step (1) and the preform inserted in step (3) are jointly cured. This refers to the conversion of these compositions and polymeric materials into the ready-to-use state, meaning a state in which the component comprising said cured compositions and polymeric materials can be used and transported as intended. The cured compositions and polymeric materials are, therefore, in particular no longer soft or tacky, having instead been conditioned to a solid coating film, solid polymeric material or solid component, respectively. Even on further exposure to crosslinking conditions as described later on below, the film or material or component no longer exhibits any substantial change in its properties such as hardness or adhesion. Thus, curing is performed at higher temperatures and/or longer curing times than the flash off previously described.

In case of the compositions applied in step (1) and (3), curing is effected by chemically curing and comprises thermochemical curing and actinic-chemical curing. In the context of the present invention, “thermochemically curable” and, respectively, the term “thermochemical curing” refer to the crosslinking of the composition (formation of a cured composition) that is initiated by chemical reaction of the functional groups of binder B, crosslinker CL and optionally reactive diluent, wherein the energetic activation of this chemical reaction is performed by means of thermal energy. The term “actinic-chemical curing” refers to the curing of the composition by use electromagnetic radiation, for example electron beam, NIR or UV radiation. In curing of a composition labeled as being chemically curable, there will of course always be some physical curing, referring to the interloping of polymer chains. The physical curing may even account for the major proportion. Nevertheless, a composition of this kind, if it comprises at least proportionally film-forming components that are chemically curable, is referred to as being chemically curable. If the fibers of the preform are at least partially coated with a polymeric material, curing is preferably effected by physical curing or by chemical curing using blocked crosslinking agents which can be unblocked at higher temperatures.

Preferably, the joint curing in step (4) is performed at a temperature of 40 to 250° C., very preferably at 60 to 70° C. or 180 to 220° C., for a duration of 40 seconds to 10 minutes, more preferably 1 to 2 minutes.

The joint curing in step (4) may be performed under an inert atmosphere, preferably under an inert gas or under vacuum. These conditions are preferably used if high curing temperatures, for example 180 to 220° C., are used in order to prevent undesired side-reactions of the compositions and polymeric materials with oxygen contained in the air.

### Step 5

The coated component obtained after step (4) is removed in step (5) from the mold cavity of the mold tool. Removal of the coated component can be performed manually or automatically. In both cases, the removal can be facilitated by moving at least one mold part relative to the other mold parts prior to removing the coated component.

### Optional Step 6

The coated component may if desired be coated directly-without a sanding operation, and optionally after simple cleaning - with further coating materials such as, for example, one or more basecoat materials and/or one or more clearcoat materials, to form one or more basecoat films and/or one or more clearcoat films. Preferably no primer-surfacer coat is applied to the component coated in accordance with the invention; instead, a basecoat film and/or a topcoat film, more particularly a clearcoat film, is applied directly. Basecoat and topcoat materials, especially clearcoat materials, which can be used are in principle all basecoat and clearcoat materials, respectively, that are conventionally used in OEM finishing or in refinishing. Such basecoat and clearcoat materials are available, for example, from BASF Coatings GmbH, with clearcoat materials that have proven themselves particularly well being those, in particular, from the EverGloss product line.

What has been said about the inventive coating composition applies mutatis mutandis with respect to further preferred embodiments of the inventive in-mold coating process.

### Overmolding Process

The present invention is further directed to an overmolding method for producing a coated component, comprising
(1) applying at least one inventive coating composition to at least one surface of a mold cavity of a mold tool;
(2) forming a coating film from the coating composition applied in step (1);
(3) inserting a substrate to be coated into the mold cavity and partially closing the mold tool;
(4) applying at least one composition into the at least partially opened mold cavity;
(5) jointly curing the coating film obtained after step (2) and the composition injected in step (4);
(6) removing the coated component from the mold cavity; and
(7) optionally applying at least one further pigmented or unpigmented coating composition being different from the coating composition applied in step (4) to the cured coating film obtained after step (4), forming a film from said at least one further coating composition and curing said at least one further coating composition.

Concerning the terms “component” and “coated component”, reference is made to the definitions listed in connection with the inventive in-mold coating process.

A substrate to be coated in accordance with the invention means is understood to mean a material which can be inserted into the mold cavity in step (3) and which has at least one surface which can be coated with a composition in step (4). Suitable substrates which can be used in step (3) are, for example, metallic substrates, plastic substrates, substrates comprising metallic and plastic parts or plastic substrates containing fibers. In case rigid substrates are used, these substrates are preferably preformed to correspond to the inner shape of the mold cavity.

### Step 1

In step (1) of the inventive overmolding method, the inventive coating composition as previously described is applied to at least one surface of the mold cavity of a mold tool as described in step (1) of the inventive in-mold coating process. The mold cavity preferably has a surface temperature in step (1) of 20 to 100° C., preferably 40 to 80° C., very preferably 60 to 70° C.

### Step 2

In step (2) of the overmolding process, a film is formed from the composition applied in step (1) as described in step (2) of the inventive in-mold coating process. With particular preference, the coating film is formed in step (2) at a temperature of preferably 40 to 80° C., very preferably 60 to 70° C. for a duration of 1 to 60 seconds, preferably 5 to 30 seconds.

### Step 3

In step (3) of the inventive overmolding process, a substrate is inserted into the mold cavity coated with the coating film formed in step (2) and the mold tool is partially closed such that the material layer obtained from the composition injected in step (4) has the desired thickness. The thickness of said material layer is therefore defined by the cavity formed when the mold tool is only closed partially. Partial closing of the mold parts can either be done manually or automatically.

The substrate can be selected from metallic substrate, plastic substrates, substrates containing plastic and metallic parts and substrates consisting of one or more layers of fibers, wherein said fibers are optionally at least partially coated with a polymeric material. Suitable metallic substrates are selected from aluminum substrates, copper substrates, zinc substrates, magnesium substrates and substrates consisting of alloys of these metals thereof as well as steel components. The term “plastic substrates” relates to substrates consisting of a polymeric material, i.e. said substrates do not comprise any fibers. Suitable polymeric materials for plastic substrates are selected from (i) polar plastics, such as polycarbonate, polyamide, polystyrene, styrene copolymers, polyesters, polyphenylene oxides and blends of these plastics, (ii) synthetic resins such as polyurethane RIM, SMC, BMC, ABS and (iii) polyolefin substrates of the polyethylene and polypropylene type with a high rubber content, such as PP-EPDM, and surface-activated polyolefin substrates. Suitable substrates consisting of one or more layers of fibers, wherein said fibers are optionally at least partially coated with a polymeric material are the preforms previously described in connection with step (3) of the inventive in-mold coating process.

### Step 4

In step (4) of the inventive overmolding method, a composition is injected into the cavity formed in step (3). The composition can be a polymeric material, a chemically curable composition forming a polymeric material or a foam material previously described in connection with step (3) of the inventive in-mold coating process. Moreover, the material can also encompass the inventive coating composition or a coating composition prepared from the inventive kit-of-parts.

In principle, all materials known to the person skilled in the art with respect to overmolding process can be used in this step of the inventive process.

### Step 5

In step (5) of the inventive overmolding method, the composition applied in step (1) and the material injected in step (4) are jointly cured. Preferably, the joint curing in step (5) is performed at a temperature of 60 to 250° C., preferably 60 to 80° C. or 180 to 220° C. for a duration of 0.5 to 24 hours, more preferably 0.5 to 10 minutes.

The joint curing in step (5) may be performed under an inert atmosphere, preferably under an inert gas or under vacuum. These conditions are preferably used if high curing temperatures, for example 180 to 220° C., are used in order to prevent undesired side-reactions of the materials to be cured with oxygen contained in the air.

### Step 6

The coated component obtained after step (5) is removed in step (6) from the mold cavity of the mold tool. Removal of the coated component can be performed manually or automatically. In both cases, the removal can be facilitated by moving at least one mold part relative to the other mold parts prior to removing the coated component.

### Optional Step 7

The coated component may if desired be coated directly-without a sanding operation, and optionally after simple cleaning - with further coating materials as described in connection with step (6) of the inventive in-mold coating process.

What has been said about the inventive coating composition and the inventive in-mold coating process applies mutatis mutandis with respect to further preferred embodiments of the inventive overmolding process.

### Inventive Coated Component

The result of the inventive in-mold coating process or the inventive overmolding process is a component coated with a coating layer obtained from the inventive coating composition.

The coated components may be used in numerous areas. Examples include the interior or exterior parts of a motor vehicle or airplane, more particularly as seat cushions or as mud flaps, steering wheels, sill trims or fender trims.

What has been said about the inventive coating composition, the inventive kit-of-parts and the inventive methods applies mutatis mutandis with respect to further preferred embodiments of the inventive coated component.

The invention is described in particular by the following embodiments: Embodiment 1: coating composition comprising — based on the total weight of the coating composition —
a) at least one solvent S in a total amount of at least 4% by weight;
b) at least one compound of the general formula (I)

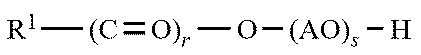

in which
   R¹ is a saturated or unsaturated, aliphatic hydrocarbon radical having 6 to 30 carbon atoms,
   AO stands for one or more alkylene oxide radicals selected from the group consisting of ethylene oxide, propylene oxide and butylene oxide,
   r is 0 or 1, and
   s is 0 to 30;
c) at least one binder B;
d) at least one crosslinker CL;
e) at least one crosslinking catalyst CCAT selected from tin carboxylates, zirconium chelates, aluminum chelates, zinc complexes, zinc carboxylates and mixtures thereof;
f) optionally at least one polyether-modified alkylpolysiloxane; and
g) optionally at least one reactive diluent,
wherein the coating composition comprises 0% by weight of alkylpolysiloxanes comprising at least one structural unit of general formula (II)

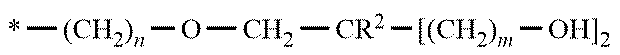

in which
R² is a saturated or unsaturated aliphatic hydrocarbon radical having 1 to 10 carbon atoms,
n is from 1 to 6, and
m is from 1 to 4.

Embodiment 2: coating composition according to embodiment 1, wherein the at least one solvent S is selected from organic solvents, water or mixtures thereof, preferably organic solvents.

Embodiment 3: coating composition according to embodiment 2, wherein the organic solvent is selected from ketones, esters, amides, methylal, butylal, 1,3-dioxolane, glycerol formal, hydrocarbons and mixtures thereof, preferably esters, very preferably n-butyl acetate and/or 1-methoxypropyl acetate and/or 2-butoxyethylacetat.

Embodiment 4: coating composition according to any of the preceding embodiments, wherein the at least one solvent S, preferably esters, very preferably n-butyl acetate and/or 1-methoxypropyl acetate and/or 2-butoxyethylacetat, are present in a total amount of 4 to 50% by weight, more preferably 4 to 40% by weight, even more preferably 4 to 30% by weight, very preferably 4 to 20% by weight, based in each case on the total weight of the coating composition.

Embodiment 5: coating composition according to any of the preceding embodiments, wherein residue R¹ in general formula (I) is a saturated or unsaturated aliphatic hydrocarbon radical having 8 to 15 carbon atoms, preferably 10 to 24 carbon atoms.

Embodiment 6: coating composition according to any of the preceding embodiments, wherein AO in general formula (I) stands for one or more alkylene oxide radicals selected from the group consisting of ethylene oxide and propylene oxide.

Embodiment 7: coating composition according to any of the preceding embodiments, wherein the amount of ethylene oxide is at least 70 mol%, preferably 70 to 99 mol%, based in each case on the total molar amount of all AO radicals present in general formula (I).

Embodiment 8: coating composition according to any of the preceding embodiments, wherein s in general formula (I) is 0 or 2 to 28, preferably 4 to 25, very preferably 6 to 20.

Embodiment 9: coating composition according to any of the preceding embodiments, wherein the coating composition comprises at least one compound of formula (Ia)

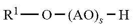

and at least one compound of formula (Ib)

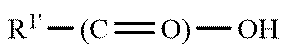

in which
R1 is a saturated or unsaturated, aliphatic hydrocarbon radical having 6 to 30 carbon atoms, preferably a saturated or unsaturated, aliphatic hydrocarbon radical having 12 to 22 carbon atoms,
R1' is a saturated or unsaturated, aliphatic hydrocarbon radical having 6 to 30 carbon atoms, preferably an unsaturated, aliphatic hydrocarbon radical having 21 carbon atoms,
AO stands for one or more alkylene oxide radicals selected from the group consisting of ethylene oxide, propylene oxide and butylene oxide, preferably ethylene oxide, and
s is 2 to 28, preferably 6 to 20;

Embodiment 10: coating composition according to any of the preceding embodiments, wherein the at least one compound of general formula (I) is present in a total amount of 0.1 to 10% by weight, more preferably 0.4 to 7% by weight, even more preferably 0.6 to 6% by weight, very preferably 0.8 to 4% by weight, based in each case on the total weight of the coating composition.

Embodiment 1011: coating composition according to any of the preceding embodiments, wherein the at least one binder B is selected from the group consisting of (i) poly(meth)acrylates, more particularly hydroxy-functional and/or carboxylate-functional and/or amine-functional poly(meth)acrylates, (ii) polyurethanes, more particularly hydroxy-functional and/or carboxylate-functional and/or amine-functional polyurethanes, (iii) polyesters, more particularly polyester polyols and polycarbonate polyols, (iv) polyethers, more particularly polyether polyols, (v) copolymers of the stated polymers, and (vi) mixtures thereof, preferably (i) hydroxy-functional poly(meth)acrylates and/or (ii) hydroxy-functional polyurethanes and/or (iii) polyesters, more particularly polyester polyols and polycarbonate polyols and/or (iv) polyethers, more particularly polyether polyols.

Embodiment 12: coating composition according to any of the preceding embodiments, wherein the at least one binder B is selected from
branched polyester polyols and/or hydroxy-functional poly(meth)acrylates or
hydroxy-functional poly(meth)acrylates and linear aliphatic polycarbonate polyols.

Embodiment 13: coating composition according to embodiment 12, wherein the branched polyester polyol has a hydroxy content of 5 to 25%, preferably 10 to 20%, very preferably 12 to 18%, as determined according to DIN 53240-2:2007-11 and/or has an acid number of 0 to 6 mg KOH/g solids, preferably 1 to 3 mg KOH/g solids, as determined according to DIN EN ISO 2114:2002-06 and/or a viscosity at 23° C. of 1,000 to 4,000 mPa*s, preferably 1,300 to 3,000 mPa*s, very preferably 1,600 to 2,200 mPa*s, as determined according to DIN EN ISO 3219:1994-10, procedure A.3.

Embodiment 14: coating composition according to embodiment 12 or 13, wherein the branched polyester polyol is present in a total amount (solids content) of 1 to 65% by weight, preferably 2 to 55% by weight, very preferably 3 to 5% by weight or 35 to 45% by weight, based in each case on the total amount of the coating composition.

Embodiment 15: coating composition according to any of embodiments 12 to 14, wherein the hydroxy-functional poly(meth)acrylate has a hydroxyl number of 50 to 200 mg KOH/g, preferably of 90 to 160 mg KOH/g, more particularly of 110 to 130 mg KOH/g or of 135 to 145 mg KOH/g, as determined according to DIN 53240-2:2007-11, procedure A and/or has an acid number of 0 to 15 mg KOH/g solids, more preferably 1 to 10 mg KOH/g solids, very preferably 1 to 4 mg KOH/g solids or 6 to 9 mg KOH/g solids, as determined according to DIN EN ISO 2114:2002-06 and/or has a number-average molecular weight Mₙ of 800 to 5,000 g/mol, preferably 1,000 to 4,000 g/mol, very preferably 1,100 to 2,400 g/mol or 1,700 to 3,000 g/mol, as determined with gel permeation chromatography using polystyrene as internal standard.

Embodiment 16: coating composition according to any of embodiments 12 to 15, wherein the hydroxy-functional poly(meth)acrylate is present in a total amount (solids content) of 1 to 75% by weight, preferably 55 to 65% by weight, based in each case on the total amount of the coating composition.

Embodiment 17: coating composition according to any of embodiments 12 to 16, wherein the linear aliphatic polycarbonate polyol has a hydroxy content of 0.1 to 10 %, preferably 0.5 to 5%, very preferably 1 to 3%, as determined according to DIN 53240-2:2007-11 and/or has an acid number of 0 to 6 mg KOH/g solids, preferably 0.05 to 0.5 mg KOH/g solids, as determined according to DIN EN ISO 2114:2002-06 and/or has a viscosity at 23° C. of 5,000 to 40,000 mPa*s, preferably 10,000 to 30,000 mPa*s, very preferably 13,00 to 20,000 mPa*s, as determined according to DIN EN ISO 3219:1994-10, procedure A.3.

Embodiment 18: coating composition according to any of embodiments 12 to 17, wherein the linear aliphatic polycarbonate polyol is present in a total amount (solids content) of 10 to 40% by weight, preferably 12 to 30% by weight, very preferably 18 to 25% by weight, based in each case on the total amount of the coating composition.

Embodiment 19: coating composition according to any of the preceding embodiments, wherein the at least one binder B is present in a total amount of 40 to 95 wt.% solids, preferably 45 to 90 wt.% solids, more preferably 50 to 85 wt.% solids, very preferably 60 to 80 wt.% solids, based in each case on the total weight of the composition.

Embodiment 20: coating composition according to any of the preceding embodiments, wherein the at least one crosslinker CL is selected from amino resins, unblocked polyisocyanates, blocked polyisocyanates, polycarbodiimides and mixtures thereof, preferably polyisocyanates, very preferably unblocked polyisocyanates.

Embodiment 21: coating composition according to embodiment 20, wherein the polyisocyanate has an NCO content of 10 to 50% by weight, preferably 15 to 40% by weight, very preferably 20 to 25 % by weight or 28 to 35% by weight, as determined according to DIN EN ISO 11909:2007-05 or ASTM D 5155-2014.

Embodiment 22: coating composition according to embodiment 20 or 21, wherein the polyisocyanate comprises at least one isocyanurate ring or at least one iminooxadiazinedione ring.

Embodiment 23: coating composition according to any of embodiments 20 to 22, wherein the coating composition comprises two different polyisocyanate P1 and P2, wherein polyisocyanate P1 comprises at least one iminooxadiazinedione ring and the polyisocyanate P2 is a polymeric methylene diphenyl diisocyanate.

Embodiment 24: coating composition according to any of the preceding embodiments, wherein the at least one crosslinker CL, preferably polyisocyanates, is present in a total amount of 5 wt% to 70 wt%, preferably of 10 to 65 wt%, more particularly of 15 to 60 wt%, based in each case on the total weight of the composition.

Embodiment 25: coating composition according to any of the preceding embodiments, wherein the molar ratio of the functional groups of the crosslinker CL, more particularly of the NCO groups of the polyisocyanates, to the sum of the complementary reactive functional groups present groups in the at least one binder B, more particularly hydroxyl groups, is 1.5:1 to 1:1.5, preferably 1.2:1 to 1:1.2, more particularly 1:1.

Embodiment 26: coating composition according to any of the preceding embodiments, wherein the at least one polyether-modified alkylpolysiloxane comprises at least one structural unit (R⁴)₂(OR³)SiO_{1/2} and at least one structural unit (R⁴)₂SiO_{2/2}, where R³ is an ethylene oxide, propylene oxide, and butylene oxide group, more particularly a mixture of ethylene oxide and propylene oxide and butylene oxide groups, and R⁴ is a C₁-C₁₀ alkyl group, more particularly a methyl group.

Embodiment 27: coating composition according to any of the preceding embodiments, wherein the at least one polyether-modified alkylpolysiloxane has a molar ratio of siloxane to ethylene oxide groups to propylene oxide groups to butylene oxide groups of 6:21:15:1 to 67:22:16:1.

Embodiment 28: coating composition according to any of the preceding embodiments, wherein the at least one polyether-modified alkylpolysiloxane has a molar ratio of the structural unit (R⁴)₂(OR³)SIO_{1/2} to the structural unit (R⁴)₂SiO_{2/2} of 1:10 to 1:15, more particularly of 1:10 to 1:13.

Embodiment 29: coating composition according to any of the preceding embodiments, wherein the at least one polyether-modified alkylpolysiloxane has a refractive index of 1.4 to 1.6, preferably 1.42 to 1.46, as determined according to DIN 51423-2:2010-02 at 23° C.

Embodiment 30: coating composition according to any of the preceding embodiments, wherein the at least one polyether-modified alkylpolysiloxane has a viscosity of 300 to 1,500 mPa*s, preferably 400 to 1,000 mPa*s, very preferably 500 to 900 mPa*s, as determined according to DIN 53015:2001-02 at 23° C.

Embodiment 31: coating composition according to any of the preceding embodiments, wherein the at least one polyether-modified alkylpolysiloxane is present in a total amount of 0 to 15% by weight, preferably 1 to 12% by weight, very preferably 1.5 to 10% by weight, based in each case on the total weight of the coating composition.

Embodiment 32: coating composition according to any of the preceding embodiments, wherein the at least one reactive diluent is selected from hydroxy-group containing compounds, preferably polyethylene oxide and/or polypropylene oxide, very preferably polypropylene oxide.

Embodiment 33: coating composition according to any of the preceding embodiments, wherein the at least one reactive diluent has a weight-average molecular weight M_{w} of 500 to 1,500 g/mol, preferably 600 to 1,200 g/mol, very preferably 800 to 1,000 g/mol, as determined by gel permeation chromatography using polystyrene as internal standard

Embodiment 34: coating composition according to any of the preceding embodiments, wherein the at least one reactive diluent has a kinematic viscosity at 20° C. of 100 to 400 mm²/s (cst), preferably of 140 to 200 mm²/s (cst), very preferably of 170 to 200 mm²/s (cst), as determined according to DIN 51562:1999-01.

Embodiment 35: coating composition according to any of the preceding embodiments, wherein the at least one reactive diluent is present in a total amount of 0 to 5% by weight, preferably 0.1 to 3% by weight, very preferably 0.3 to 1% by weight, based in each case on the total amount of the coating composition.

Embodiment 36: coating composition according to any of the preceding embodiments, wherein residue R² in general formula (II) is a linear saturated aliphatic hydrocarbon radial having 2 carbon atoms, n is 3 and m is 1.

Embodiment 37: coating composition according to any of the preceding embodiments, wherein the at least one crosslinking catalyst CCAT is selected from tin carboxylates, very preferably from dioctyltin dilaurate.

Embodiment 38: coating composition according to any of the preceding embodiments, wherein the tin carboxylate, preferably the dioctyltin dilaurate, has a tin content of 10 to 25%, preferably 12 to 20%, based on the total weight of the tin carboxylate.

Embodiment 39: coating composition according to any of the preceding embodiments, wherein the at least one crosslinking catalyst CCAT is present in a total amount of 0.1 to 5% by weight, preferably 0.2 to 3% by weight, very preferably 0.2 to 0.8 % by weight, based on the total weight of the coating composition.

Embodiment 40: coating composition according to any of the preceding embodiments, wherein the coating composition further comprises at least one pigment and/or filler.

Embodiment 41: coating composition according to embodiment 40, wherein the at least one pigment and/or filler is present in a total amount of 0.1 to 10% by weight, based on the total weight of the coating composition

Embodiment 42: coating composition according to any of the preceding embodiments, wherein the coating composition further comprises at least one additive, preferably selected from wetting agents and/or dispersants, rheological assistants, flow control agents, UV absorbers, and mixtures thereof.

Embodiment 43: coating composition according to embodiment 42, wherein the at least one additive is present in a total amount of 0.1 to 10% by weight, based on the total weight of the coating composition

Embodiment 44: method for producing a coated component, comprising
(1) applying at least one coating composition as claimed in any of embodiments 1 to 43 to at least one surface of a mold cavity of a mold tool;
(2) forming a coating film from the coating composition applied in step (1);
(3) applying at least one composition forming the component into the mold cavity coated with the coating film, wherein the mold tool is closed prior or after application of the composition forming the component or inserting at least one preform into the mold cavity coated with the coating film and closing the mold tool;
(4) jointly curing the coating film obtained after step (2) and the composition applied in step (3) and the preform inserted in step (3);
(5) removing the coated component from the mold cavity; and
(6) optionally applying at least one further pigmented or unpigmented coating composition being different from the coating composition applied in step (1) to the cured coating film obtained after step (4), forming a film from said at least one further coating composition and curing said at least one further coating composition.

Embodiment 45: method according to embodiment 44, wherein the mold cavity has a surface temperature in step (1) of 20 to 100° C., preferably 40 to 80° C., very preferably 60 to 70° C.

Embodiment 46: method according to embodiment 44 or 45, wherein the coating film is formed in step (2) at a temperature of 40 to 80° C., more preferably 60 to 70° C. for a duration of 1 to 60 seconds, preferably 5 to 30 seconds.

Embodiment 47: method according to any of embodiments 44 to 46, wherein the composition forming the component is selected from (i) polymer foam materials, more particularly selected from polyurethane foam materials, polystyrene foam materials, polyester foam materials, butadiene styrene blockcopolymer foam materials and aminoplast foam materials, very preferably from polyurethane foam materials or (ii) plastic materials, more particularly selected from epoxides, polyamides, polycarbonates, polyesters, polystyrenes, polyurethanes and acrylonitrile butadiene styrenes, very preferably from epoxides and/or polyurethanes and/or polycarbonates.

Embodiment 48: method according to any of embodiments 44 to 46, wherein the at least one preform consists of one or more layers of fibers selected from carbon fibers, glass fibers, aramid fibers, basalt fibers and mixtures thereof, preferably glass fibers, wherein said preform is optionally soaked or coated with a polymeric material selected from polyesters, polyurethanes, epoxy resins, vinyl ester resins, polyamide resins and formaldehyde phenol resins, preferably polyesters or polyurethanes.

Embodiment 49: method according to any of embodiments 44 to 48, wherein the joint curing in step (4) is performed at a temperature of 40 to 250° C., very preferably at 60 to 70° C. or 180 to 220° C., for a duration of 40 seconds to 10 minutes, preferably 1 to 2 minutes.

Embodiment 50: method according to any of embodiments 44 to 49, wherein the joint curing in step (4) is performed under an inert atmosphere, preferably under an inert gas or under vacuum

Embodiment 51: method for producing a coated component, comprising
(1) applying at least one coating composition as claimed in any of embodiments 1 to 43 to at least one surface of a mold cavity of a mold tool;
(2) forming a coating film from the coating composition applied in step (1);
(3) Inserting a substrate into the mold cavity of the mold tool and partially closing the mold tool;
(4) applying at least one composition into the at least partially opened mold cavity;
(5) jointly curing the coating film obtained after step (2) and the composition injected in step (4);
(6) removing the coated component from the mold cavity; and
(7) optionally applying at least one further pigmented or unpigmented coating composition being different from the coating composition applied in step (4) to the cured coating film obtained after step (4), forming a film from said at least one further coating composition and curing said at least one further coating composition.

Embodiment 52: method according to embodiment 51, wherein the at least one substrate is selected from metallic substrates, plastic substrates, substrates containing metallic and plastic parts and substrates consisting of one or more layers of fibers, wherein said fibers are optionally at least partially coated with a polymeric material.

Embodiment 53: method according to embodiment 51 or 52, wherein the curing in step (5) is performed at a temperature of 60 to 250° C., preferably 60 to 80° C. or 180 to 220° C. for a duration of 0.5 to 24 hours, preferably 0.5 to 10 minutes.

Embodiment 54: method according to any of embodiments 51 to 53, wherein the curing in step (5) is performed under the exclusion of air, preferably by using an inert gas or by applying a vacuum.

Embodiment 55: coated component obtained by a method as claimed in any of embodiments 44 to 54.

Embodiment 56: coated component according to embodiment 55, wherein the coated component is an interior or exterior part of a motor vehicle or airplane.

### EXAMPLES

The present invention will now be explained in greater detail through the use of working examples, but the present invention is in no way limited to these working examples. Moreover, the terms “parts”, “%” and “ratio” in the examples denote “parts by mass”, “mass %” and “mass ratio” respectively unless otherwise indicated.

### 1. Methods of Determination

### 1.1 Solids Content (Solids, Nonvolatile Fraction)

The nonvolatile fraction is determined according to ASTM D2369 (date: 2015). In this procedure, 2 g of sample are weighed out into an aluminum dish which has been dried beforehand, and the sample is dried in a drying cabinet at 110° C. for 60 minutes, cooled in a desiccator, and then reweighed. The residue, relative to the total amount of sample introduced, corresponds to the nonvolatile fraction.

### 1.2 Determination of Removal of Coating Films from Steel and Aluminum Panels

Directly after curing, the warm coating film is detached at one point using a scalpel and removed from the respective panel by hand. If the coating film could be removed completely without destruction, the rating is “OK”. If the coating film is destroyed during removal or could only be partially removed, the rating is “not OK”.

### 1.3 Determination of Demolding of Coated Components from Metallic Molds

The coated component was removed from the mold cavity manually without any tools. If the coated component could be removed easily and completely without any visual damages, the rating was “OK”. Otherwise, the rating was “not OK”.

### 1.4 Determination of Acid Number

The acid number is determined according to DIN EN ISO 2114 (date: June 2002), using “method A”. The acid number corresponds to the mass of potassium hydroxide in mg required to neutralize 1 g of sample under the conditions specified in DIN EN ISO 2114. The acid number reported corresponds here to the total acid number as specified in the DIN standard, and is based on the solids content.

### 1.5 Determination of OH Number

The OH number is determined according to DIN 53240-2:2007-11. The OH groups are reacted by acetylation with an excess of acetic anhydride. The excess acetic anhydride is subsequently split by addition of water to form acetic acid, and the entire acetic acid is back-titrated with ethanolic KOH. The OH number indicates the quantity of KOH in mg that is equivalent to the amount of acetic acid bound in the acetylation of 1 g of sample. The OH number is based on the solids content of the sample.

### 1.6 Determination of Number-Average and Weight-Average Molecular Weight

The number-average molecular weight (Mₙ) is determined by gel permeation chromatography (GPC) according to DIN 55672-1 (March 2016). Besides the number-average molecular weight, this method can also be used to determine the weight-average molecular weight (M_{w}) and also the polydispersity d (the ratio of weight-average molecular weight (M_{w}) to number-average molecular weight (Mₙ)). Tetrahydrofuran is used as the eluent. The determination is made against polystyrene standards. The column material consists of styrene-divinylbenzene copolymers.

### 1.7 Determination of Cross-Hatch Adhesion Properties

The cross-hatch adhesion properties of coating films formed on the panel or component was determined according to DIN EN ISO 2409:2013-06. Using a defined tool, a right angle lattice pattern is cut into the coating film, penetrating all the way to the substrate. Afterwards, an adhesive strip is attached and pressed to the pattern and subsequently removed at a controlled rate. If the cut coating film is still completely adhering to the substrate after removal of the adhesive strip, the rating is “OK”. Otherwise, the rating is “not OK”.

### 1.8 Determination of Steam Jet Adhesion

The steam-jet adhesion is determined according to DIN 55662:2009-12. Using a defined tool, a right angle lattice pattern is cut into the coating film, penetrating all the way to the substrate. Afterwards, the cut substrate is treated with a steam jet having a defined temperature and pressure. If the cut coating film is not removed during the treatment with the steam jet, the rating is “OK”. Otherwise, the rating is “not OK”.

### 1.9 Determination of Recoating Properties

The recoating properties of the formed coating layers is determined by using one or several of the following criteria:
the visual impression of the multilayer coating obtained after re-coating with commercially available conductive primers and/or basecoat compositions and/or clearcoat compositions,
the adhesion of the primer and/or basecoat and/or clearcoat film to the coating film formed on the substrate as determined according to points 1.7 and 1.8,
the adhesion of the multilayer coating on the substrate as determined according to points 1.7 and 1.8.

If several criteria are used, the overall rating is “OK” if each criteria is rated “OK”. The visual impression is rated “OK” if no flow defects, craters or other negative visual defects on the coating film are detected. Otherwise, the rating is “not OK”. Concerning the rating of the adhesion, reference is made to points 1.7 and 1.8 above.

### 1.10 Determination of Curing Behavior of Coating Compositions

The curing behavior of prepared coating compositions, i.e. the temperature necessary to induce a chemical crosslinking (called “on-set temperature” hereinafter) as well as the time necessary at a defined temperature to achieve full crosslinking of the coating composition (called “off-set time” hereinafter) were determined by dynamic mechanical analysis (DMA) as follows.

### Determination of “On-Set Temperature”

The prepared liquid coating composition is applied onto a flexible carrier material, said carrier material being fixed inside the DMA device. Afterwards, the carrier material comprising the liquid coating composition (called sample afterwards) is excited to a sinusoidal oscillation with constant frequency and amplitude, while the sample temperature is increased from 23° C. to 200° C. When the crosslinking of the coating composition starts, the strength of the sample and thus the force required for oscillation increases abruptly. The temperature at which this increase in oscillation occurs corresponds to the “on-set temperature”.

### Determination of “Off-Set Time”

The prepared liquid coating composition is applied onto a flexible carrier material, said carrier material being fixed inside the DMA device. Afterwards, the carrier material comprising the liquid coating composition (called sample afterwards) is excited to a sinusoidal oscillation with constant frequency and amplitude while the sample temperature is increase abruptly to 80° C. Due to the beginning crosslinking of the coating composition, the force required for oscillation increases until a plateau is reached. The time until this plateau is reached corresponds to the “off-set time”.

### 2. Preparation of Coating Compositions

With regard to the stated formulation constituents and their quantities, the following should be borne in mind: any reference to a commercial product is to exactly that commercial product, irrespective of the particular principal name selected for the constituent.

The inventive coating compositions C—I1 to C—I6 and the comparative coating compositions C—C1 to C—C5 are obtained by mixing the ingredients listed in Table 1 until a homogenous coating composition is obtained.

Table 1

Composition of coating compositions C—I1 to C—I6 and C—C1 to C—C5 (amounts in % by weight)

| | C—I1 | C—I2 | C—I3 | C—I4 | C—I5 | C—I6 | C—C1 | C—C2 | C—C3 | C—C4 | C—C5 |
|---|---|---|---|---|---|---|---|---|---|---|---|
| Desmophen® VP LS 2249/1¹⁾ | 37.2 | 35.6 | 34.6 | 4.3 | - | - | 43.3 | 37.2 | 35.6 | 34.6 | 4.3 |
| Acrylique TSA Uno²⁾ | - | - | - | 57.2 | - | - | - | - | - | - | 57.2 |
| Acrylique 3,5 sechage rapid³⁾ | - | - | - | - | 39.2 | 37.7 | - | - | - | - | - |
| Desmophen® C1200⁴⁾ | - | - | - | - | 21.4 | 20.6 | - | - | - | - | - |
| Pluriol P 900 C⁵⁾ | 0.5 | 0.5 | 0.4 | 0.8 | 0.7 | 0.7 | 0.4 | 0.5 | 0.5 | 0.4 | 0.8 |
| Borchi Gol OL 17⁶⁾ | 7.0 | 9.4 | 1.9 | 4.1 | 3.6 | 3.4 | - | 7.0 | 9.4 | 1.9 | 4.1 |
| Additiv MI 8010⁷⁾ | 2.8 | 3.8 | 0.8 | 1.6 | 1.4 | 1.4 | - | 2.8 | 3.8 | 0.8 | 1.6 |
| TIB KAT 216⁸⁾ | 0.3 | 0.4 | 0.3 | 0.6 | 0.6 | 0.6 | 0.3 | - | - | - | - |
| K-Kat XK-651 ⁹⁾ | - | - | - | - | - | - | - | 0.3 | 0.5 | 0.3 | 0.7 |
| Butylactetat | 3.1 | 3.2 | 2.6 | 5.5 | 9.7 | 9.3 | 3.0 | 3.1 | 3.2 | 2.6 | 5.5 |
| 1-Methoxy-2-proplyacetat | 3.1 | 3. | 2.6 | 5.5 | 9.7 | 9.3 | 3.0 | 3.1 | 3. | 2.6 | 5.5 |
| Butoxyethanolacetat | 0.7 | 0.7 | 0.6 | 1.2 | 2.2 | 2.1 | 0.7 | 0.7 | 0.7 | 0.6 | 1.2 |
| Lupranat® M 20 S¹⁰⁾ | 45.2 | 43.3 | - | 8.2 | 11.5 | - | 49.3 | 45.2 | 43.3 | - | 8.2 |
| Desmodur® N 3900¹¹⁾ | - | - | 56.4 | 10.9 | - | 14.9 | - | - | - | 56.4 | 10.9 |
| Solid content [%] | 53.6 | 57.4 | 49.1 | 58.2 | 61.9 | 61.4 | 45.6 | 53.2 | 56.0 | 48.3 | 57.8 |

¹⁾ branched short-chain polyester polyol; OH content = 15.5%, acid number = 2 mg KOH/g solids, viscosity at 23° C. = 1,900 ± 200 mPa*s (Covestro AG Deutschland), ²⁾ hydroxy-functional polyacrylate; OH number = 115-125 mg KOH/g solids, acid number = 3 mg KOH/g solids, Mₙ ≈ 1,200-2,200 g/mol, Mw ≈ 3,500-5,300 (BASE SE), ³⁾ hydroxy-functional poly(meth)acrylate; OH number = 140 mg KOH/g solids, acid number = 8 mg KOH/g solids, Mₙ ≈ 1,800-2,800 g/mol, M_{w} ≈ 5,200-7,200 (BASE SE), ⁴⁾ linear aliphatic polycarbonate polyol; OH content = 1.7%, acid number = 0.1 mg KOH/g solids, OH number = 56.1 mg KOH/g solids (Covestro AG Deutschland), ⁵⁾ Polypropylene glycol; M_{w} ≈ 900 g/mol, kinematic viscosity at 20° C. ≈180 mm²/s (cst) (BASF SE), ⁶⁾ polyether-modified methylpolysiloxane; n_{D} at 23° C. = 1.445-1.449, viscosity at 23° C. = 600-800 mPa*s (Borchers GmbH), ⁷⁾ mixture of compounds of general formula (I) consisting of (a) R¹ = mixture of saturated and unsaturated hydrocarbon radicals having 12 to 22 carbon atoms, r = 0, AO = mixture of primarily ethylene oxide units and a few propylene oxide units (Mₙ ≈ 650 g/mol); and (b) R¹ = unsaturated hydrocarbon radical having 21 carbon atoms and s = 0 (Münch Chemie International GmbH), ⁸⁾ Dioctyltin dilaurate, tin content = 15.5 to 17.0% (supplied by TIB Chemicals), ⁹⁾ Bismuth neodecanoate, bismuth content = 23% (supplied by King Industries) ¹⁰⁾ Methylene diphenyl diisocyanate; NCO content = 31.5 Gew.-%, viscosity at 25° C. = 210 mPa*s (BASF SE),
¹¹⁾ hexamethylene diisocyanate trimer of iminooxadiazinedione type; NCO content = 23.5 wt% (Covestro AG Deutschland)

### 3. Preparation of Coating Films From Coating Compositions

### 3.1 Preparation of Coating Films on Metal Substrates/Molds

The coating compositions C-11 to C—I4 and C—C1 prepared according to point 2. are each applied using a doctor blade on the respective metal substrate or metal mold and cured at 80° C. for approximately 10 minutes to form coating films CC—I1 to CC—I6 and CC-C1.

### 3.2 Preparation of Coated Components

The inventive coating compositions C—I5 and C—I6 are each applied manually pneumatically (nozzle 1.2 to 1.4 at 1.2 to 2 bar) onto all surfaces of the mold cavity of a mold tool in plate form (mold tool consists of a metal alloy; plate size = 300 mm × 200 mm × 10 mm; unstructured) at a mold temperature of 65° C. After flashing off each applied composition for 10 to 25 seconds, the mold cavity is partially closed and a component forming composition were coated with a primer coating composition (JU71-7S55 Combiblock Schiefergrau, weight ratio of base varnish to hardener = 100 : 15, supplied by BASF Coatings GmbH), flashed off for 10 minutes at 23° C. and afterwards cured at 80° C. for 20 minutes. The resulting dry film thickness of the obtained cured primer layer was 10 to 14 µm.

Afterwards, a commercially available basecoat material (JW07-92TH Coba VWL C9X deepblack, supplied by BASF Coatings GmbH) is applied such that the resulting dry film thickness is 15 µm. The basecoat material was flashed for 10 minutes at 23° C. and cured for 10 minutes at 80° C.

After the basecoat material has been cured, a commercially available clearcoat material (JF71-0312 Evergloss 905, supplied by BASF Coatings GmbH) was applied such that the resulting dry film thickness is 40 µm. The clear coat layer was flashed for 10 minutes at 23° C. and subsequently cured at 80° C. for 30 minutes.

### 4.2 Preparation of Recoated Components

Preparation of recoated components was performed as described in point 4.1 using the coated component obtained after point 3.2.

### 5. Results

### 5.1 Curing Behavior of Coating Compositions C-11 to C—I4 and C—C2 to C—C5

The curing behavior of inventive coating compositions C—I1 to C—I4 comprising a tin carboxylate as curing catalyst CCAT as well as comparative coating compositions C-C2 to C—C5 comprising a bismuth carboxylate as curing catalyst CCAT was compared by determination of the on-set temperature and the off-set time at 80° C. as described in point 1.10 above. The obtained results are listed in Table 2.

Table 2

On-set temperature and off-set time of coating compositions comprising different curing catalysts

| Coating composition | On-set temperature [°C] | Off-set time @80° C. [min] |
|---|---|---|
| C—I1 | 49 | 13 |
| C—* | 71 | 57 |
| C—I2 | 60 | 18 |
| C—C3* | 73 | 25 |
| C—I3 | 51 | 13 |
| C—C4* | 75 | 27 |
| C—I4 | 30 | 22 |
| C—C5* | 54 | 51 |

* comparative

The on-set temperature indicates the begin of the curing reaction while the off-set time @80° C. indicates the time necessary at this temperature to obtain a fully cured coating film. The inventive coating compositions C—I1 to C—I4 comprising a tin carboxylate as curing catalyst CCAT show significantly lower on-set temperatures and off-set times at 80° C. than the comparative coating compositions C—C2 to C—C4 comprising a bismuth carboxylate as curing catalyst CCAT. Thus, the use of the tin carboxylate curing catalyst results in a significantly faster curing reaction at 80° C., thus allowing to reduce the curing temperature while keeping the curing time within acceptable limits. Therefore, the inventive coating compositions can be used in combination with heat sensitive substrates. Moreover, the inventive coating compositions allow faster cycle times during production due to the lower curing time necessary to achieve complete curing of the inventive coating compositions as compared to the comparative coating compositions.

### 5.2 Removal of Coating Films From Steel and Aluminum Panels

The removal of the coating films prepared according to point 3.1 from steel and aluminum panels was performed as previously described. The obtained results are listed in Table 3.

Table 3

Demolding properties of coating films from steel and aluminum panels

| | | | |
|---|---|---|---|
| Coating composition | Coating film | steel panel | Aluminum panel |
| C—I1 | CC—I1 | OK | OK |
| C—I2 | CC—I2 | OK | OK |
| C—I3 | CC—I3 | OK | OK |
| C—I4 | CC—I4 | OK | OK |
| C—C1* | CC—C1 | Not OK | Not OK |

* comparative

The coating films formed from inventive coating compositions C—I1 to C—I4 can be easily and fully removed when still hot from both steel and aluminum panels without any damages. Removal of the hot coating films from the substrate is essential for the use of the inventive coating compositions in industrial molding process. In contrast, the comparative coating film CC—C1 obtained from a coating composition not containing a compound of general formula (I) could not be removed from the substrate without destroying the coating film. Thus, the use of the at least one compound of general formula (I) in a solvent-based coating system comprising a binder and a crosslinker results in improved removal/demolding properties of the coating film obtained from said coating system. Moreover, the excellent removal properties are achieved irrespective of the binder/hardener system used in the coating composition. Thus, the present invention allows to tailor the binder/hardener system to the required application without negatively influencing the removal/demolding properties obtained from cured inventive coating compositions.

### 5.3 Demolding of Coated Component From Metallic Mold Cavity

The demolding of the coated component prepared according to point 3.2 from the metallic mold cavity was performed as previously described. The components coated with coating films formed from inventive coating compositions C—I5 and C—I6 could be easily and completely removed from the mold cavity by hand without and visual damages. Thus, the demolding properties of the coated components is rated as “OK”.

This excellent demolding of the coated components was achieved without the use of an external release agent, which has to be removed before re-coating. Additionally, short flash off times are sufficient in order to achieve excellent demolding properties, thus rendering the inventive coating compositions suitable for industrial process requiring short process times. Moreover, the excellent demolding is achieved irrespective of the binder/hardener system used in the coating composition. Thus, the present invention allows to tailor the binder/hardener system to the required application without negatively influencing the demolding properties obtained from cured inventive coating compositions.

### 5.4 Cross-Hatch Adhesion of Coating Films on Steel and Aluminum Substrates and Coated Components

The cross-hatch adhesion of coating films obtained from inventive coating compositions C—I1 and C—I2 as well as comparative coating composition C—C1 on steel and aluminum panels was determined as previously described. Moreover, the cross-hatch adhesion of the coating films CC—I5 and CC—I6 formed from composition C—I5 and C—I6, respectively, on the components as well as the interlayer adhesion between CC—I5 or CC—I6 and the overlaying conductive primer and/or basecoat and/or clearcoat was determined. Finally, the cross-hatch adhesion of the multilayer coating (i.e. coating film CC—I5 or CC—I6 and conductive primer and/or basecoat and/or clearcoat) was determined. The results are listed in Tables 4 and 5.

Table 4

Results of cross-hatch adhesion of coating films on steel and aluminum substrates

| | | | |
|---|---|---|---|
| Coating composition | Coating film | steel panel | Aluminum panel |
| C—I1 | CC—I1 | OK | OK |
| C—I2 | CC—I2 | OK | OK |
| C—C1* | CC—C1 | OK | OK |

* comparative

Table 5

Results of cross-hatch adhesion of coating films on components

| | | | | |
|---|---|---|---|---|
| Coating composition | Coating film | Adhesion coating film on component | Interlayer adhesion | Adhesion multilayer on substrate |
| C—I5 | CC—I5 | OK | OK | OK |
| C—I6 | CC—I6 | OK | OK | OK |

The results demonstrate that the use of the compound of general formula (I) facilitating removal/demolding of the coating films CC—11 and CC—I2 from the substrate does not negatively influence the adhesion of said coating films on the substrate even at rather high concentrations of said compound of general formula (I) as compared to the comparative coating film not containing compound of general formula (I) (CC—C1). Moreover, the use of said compound of general formula (I) does also not influence the interlayer adhesion or the adhesion of the multilayer coating of coated component re-coated with at least one further coating layer. Thus, the inventive coating compositions are especially suitable to provide coated components which can be easily demolded from the mold cavity and re-coated without intermediate sanding and/or cleaning without negatively influencing the adhesion of coating films on the component.

### 5.5 Steam Jet Adhesion of Coated Components

The steam jet adhesion of the coating films CC—I5 and CC—I6 formed from composition C—I5 and C—I6, respectively, on the components as well as the interlayer adhesion between CC—I5 or CC—I6 and the overlaying conductive primer and/or basecoat and/or clearcoat was determined. Additionally, the steam jet adhesion of the multilayer coating (i.e. coating film CC—I5 or CC—I6 and conductive primer and/or basecoat and/or clearcoat) was determined. The results are listed in Table 6.

Table 6

Results of steam jet adhesion of coating films on components

| | | | | |
|---|---|---|---|---|
| Coating composition | Coating film | Adhesion coating film on component | Interlayer adhesion | Adhesion multilayer on substrate |
| C—I5 | CC—I5 | OK | OK | OK |
| C—I6 | CC—I6 | OK | OK | OK |

The results demonstrate that the use of compound of general formula (I) in coating films CC—I5 and CC—I6 facilitating the demolding of the coated components from the mold cavity does not negatively influence the adhesion of said coating films on the component. Moreover, the use of said compound of general formula (I) does also not influence the interlayer adhesion or the adhesion of the multilayer coating of coated component re-coated with at least one further coating layer. Thus, the inventive coating compositions are especially suitable to provide coated components which can be easily demolded from the mold cavity and re-coated without intermediate sanding and/or cleaning without negatively influencing the adhesion of coating films on the component.

### 5.6 Recoating of Coating Films and Coated Components

The coating films obtained from inventive coating compositions C—I1, C—I3 and C—I4 as well as the coated components obtained from coating compositions C—I5 and C—I6 were re-coated with at least one conductive primer and/or basecoat composition and/or clearcoat composition as previously described without any intermediate sanding and/or cleaning steps. The results are listed in Table 7.

Table 7

Recoating properties of coating films formed on steel panels, aluminum panels and coated components

| | | | | |
|---|---|---|---|---|
| Coating composition | Coating film | steel panel | Aluminum panel | Coated component |
| C—I1 | CC—I1 | OK | OK | |
| C—I3 | CC—I3 | OK | OK | |
| C—I4 | CC—I4 | OK | OK | |
| C—I5 | CC—I5 | | | OK |
| C—I6 | CC—I6 | | | OK |

All coating films formed on steel and aluminum substrates as well as on the components can be coated without prior sanding and/or cleaning steps with at least one further commercially available coating composition without a negative influence on the appearance of the obtained multilayer coating. Thus, the use of compound of general formula (I) facilitating removal of the coating film/demolding of the coated component does not negatively influence the re-coating properties of the obtained coating layers. Surprisingly, the excellent re-coating properties are obtained irrespective of the binder/hardener system and the concentrations of the component of general formula (I).

### 6. Conclusion

The use of the compound of general formula (I), optionally in the presence of the polyether-modified alkylpolysiloxane, in coating compositions comprising at least one binder and at least on hardener result in excellent demolding properties without negatively influencing the adhesion, especially cross-hatch and steam jet adhesion, and the re-coating properties of the cured coating films. The excellent demolding, adhesion and recoating properties are obtained irrespective of the binder/hardener system or pigments/fillers used, thus rendering the inventive coating compositions highly versatile with respect to the adaption of the binder/hardener system or the pigmentation to specific needs. Moreover, the inventive coating composition require low curing temperatures as well as short flash off and curing times, thus rendering them suitable for processes requiring short cycle times as well as for the coating of heat sensitive substrates. In summary, the inventive coating compositions allow to produce coated components without the use of external release agents and are therefore highly suitable in in-mold coating processes.

1. Coating A coating composition comprising, based on the total weight of the coating composition:
a) at least one solvent S in a total amount of at least 4% by weight;
b) at least one compound of the general formula (I) 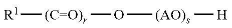
in which
R¹ is a saturated or unsaturated, aliphatic hydrocarbon radical having 6 to 30 carbon atoms,
AO stands for one or more alkylene oxide radicals selected from the group consisting of ethylene oxide, propylene oxide and butylene oxide,
r is 0 or 1, and
s is 0 to 30;
c) at least one binder B;
d) at least one crosslinker CL;
e) at least one crosslinking catalyst CCAT selected from the group consisting of tin carboxylates, zirconium chelates, aluminum chelates, zinc complexes, zinc carboxylates and mixtures thereof;
f) optionally at least one polyether-modified alkylpolysiloxane; and
g) optionally at least one reactive diluent,
wherein the coating composition comprises 0% by weight of alkylpolysiloxanes comprising at least one structural unit of general formula (II) 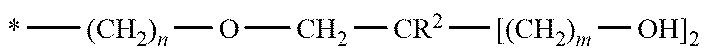
in which
R² is a saturated or unsaturated aliphatic hydrocarbon radical having 1 to 10 carbon atoms,
n is from 1 to 6, and
m is from 1 to 4.

2. Coating The coatin2 composition according to claim 1, wherein the residue R¹ in general formula (I) is a saturated or unsaturated aliphatic hydrocarbon radical having 8 to 15 carbon atoms.

3. Coating The coating composition according to claim 1, wherein AO in general formula (I) stands for one or more alkylene oxide radicals selected from the group consisting of ethylene oxide and propylene oxide.

4. Coating The coating composition according to claim 1, wherein s in general formula (I) is 0 or 2 to 28 .

5. Coating The coating composition according to claim 1, wherein the at least one compound of general formula (I) is present in a total amount of 0.1 to 10% by weight based on the total weight of the coating composition.

6. Coating The coating composition according to claim 1, wherein the at least one binder B is selected from the group consisting of (i) poly(meth)acrylates, (ii) polyurethanes, (iii) polyesters, (iv) polyethers, (v) copolymers of the stated polymers, and (vi) mixtures thereof.

7. Coating The coating composition according to claim 1, wherein the at least one binder B is selected from the group consisting of
branched polyester polyols and/or hydroxy-functional poly(meth)acrylates and
hydroxy-functional poly(meth)acrylates and linear aliphatic polycarbonate polyols.

8. Coating The coating composition according to claim 1, wherein the at least one binder B is present in a total amount of 40 to 95 wt% solids based on the total weight of the composition.

9. Coating The coating composition according to claim 1, wherein the at least one crosslinker CL is selected from the group consisting of amino resins, unblocked polyisocyanates, blocked polyisocyanates, polycarbodiimides and mixtures thereof.

10. Coating The coating composition according to claim 1, wherein the at least one crosslinker CL is present in a total amount of 5 wt% to 70 wt% based on the total weight of the composition.

11. Coating The coating composition according to claim 1, wherein the molar ratio of the functional groups of the crosslinker CL to the sum of the complementary reactive functional groups present groups in the at least one binder B is 1.5:1 to 1:1.5 .

12. Coating The coating composition according to claim 1, wherein the residue R² in general formula (II) is a linear saturated aliphatic hydrocarbon radial having 2 carbon atoms, n is 3 and m is 1.

13. A method for producing a coated component, the method comprising:
(1) applying at least one coating composition as claimed in claim 1 to at least one surface of a mold cavity of a mold tool;
(2) forming a coating film from the coating composition applied in step (1);
(3) applying at least one composition forming the component into the mold cavity coated with the coating film, wherein the mold tool is closed prior to or after application of the composition forming the component or inserting at least one preform into the mold cavity coated with the coating film and closing the mold tool;
(4) jointly curing the coating film obtained after step (2), the composition applied in step (3), and the preform inserted in step (3);
(5) removing the coated component from the mold cavity; and
(6) optionally applying at least one further pigmented or unpigmented coating composition different from the coating composition applied in step (1) to the cured coating film obtained after step (4), forming a film from said at least one further coating composition, and curing said at least one further coating composition.

14. A method for producing a coated component, the method comprising
(1) applying at least one coating composition as claimed in claim 1 to at least one surface of a mold cavity of a mold tool;
(2) forming a coating film from the coating composition applied in step (1);
(3) inserting a substrate into the mold cavity of the mold tool and partially closing the mold tool;
(4) applying at least one composition into the at least partially opened mold cavity;
(5) jointly curing the coating film obtained after step (2) and the composition injected in step (4);
(6) removing the coated component from the mold cavity; and
(7) optionally applying at least one further pigmented or unpigmented coating composition different from the coating composition applied in step (4) to the cured coating film obtained after step (4), forming a film from said at least one further coating composition, and curing said at least one further coating composition.

15. A coated component obtained by a method as claimed in claim 13.

16. The coating composition according to claim 1, wherein the residue R¹ in general formula (I) is a saturated or unsaturated aliphatic hydrocarbon radical having 10 to 24 carbon atoms.

17. The coating composition according to claim 1, wherein s in general formula (I) is a value between 4 and 25.

18. The coating composition according to claim 1, wherein s in general formula (I) is a value between 6 and 20.

19. The coating composition according to claim 1, wherein the at least one compound of general formula (I) is present in a total amount of 0.4 to 7% by weight based on the total weight of the coating composition.

20. The coating composition according to claim 1, wherein the at least one compound of general formula (I) is present in a total amount of 0.6 to 6% by weight based on the total weight of the coating composition.
